(19) United States
(12) Patent Application Publication
(10) Pub. No.: US 2007/0069046 A1
(43) Pub. Date: Mar. 29, 2007

(54) Apparatus and method for releasing a measure of content from a plurality of containers

(75) Inventors: Meir Eini, Ness Ziona (IL); Dov Tamarkin, Maccabim (IL); Doron Friedman, Karmei Yosef (IL); David Schuz, Moshav Gimzu (IL)

Correspondence Address: WILMER CUTLER PICKERING HALE AND DORR LLP, 60 STATE STREET, BOSTON, MA, 02109, US

(73) Assignee: Foamix Ltd., Rehovot (IL)

(21) Appl. No.: 11/520,473

(22) Filed: Sep. 12, 2006

Related U.S. Application Data
(63) Continuation-in-part of application No. 11/406,133, filed on Apr. 18, 2006.
(60) Provisional application No. 60/673,087, filed on Apr. 19, 2005.
(60) Provisional application No. 60/673,088, filed on Apr. 19, 2005.
(60) Provisional application No. 60/716,340, filed on Sep. 12, 2005.

(51) Int. Cl. B67D 5/52; F23D 11/40

(52) U.S. Cl. 239/418; 222/135; 239/304; 239/433

(57) ABSTRACT

A dispenser head for use with a plurality of containers, each of the containers having a hollow stem through which contents are dispensed when the stem is activated, includes (a) a flow guide structured and positioned to receive a plurality of pressurized containers; (b) a plurality of flow conduits disposed within the flow guide, each of the plurality of flow conduits comprising an inlet and an outlet and each said inlet capable of engagement with a respective container stem; and (c) an actuator connected to the flow guide, wherein the actuator is structured and positioned to allow simultaneous flow communication between each of the plurality of flow conduits and a respective hollow stem, allowing substantially contemporaneously dispensing and/or combining of the content from a plurality of containers.

### RELATED APPLICATIONS

This application is a continuation-in-part application of co-pending U.S. patent application Ser. No. 11/406,133, filed Apr. 18, 2006, and entitled “Apparatus and Method for Releasing a Measured Amount of Content From a Container,” which claims the benefit under 35 U.S.C. § 119(e) of U.S. Provisional Patent Application No. 60/673087, filed on Apr. 19, 2005, entitled “Foam Applicator,” and which also claims the benefit under 35 U.S.C. §119(e) of and U.S. Provisional Patent Application No. 60/673088, filed on Apr. 19, 2005, entitled “Apparatus and Method for Releasing a Measure of Content from a Container,” all of which are hereby incorporated in their entirety by reference.

This application also claims the benefit under 35 U.S.C. §119(e) of and U.S. Provisional Patent Application No. 60/716340, filed on Sep. 12, 2005, entitled “Apparatus and Method for Releasing a Measure of Content from a Container,” which is herein incorporated by reference in its entirety.

### FIELD OF THE INVENTION

The present invention relates to a method and apparatus for controlled release of contents from a plurality of containers. In particular, the present invention relates to method and apparatus for releasing and mixing at least two compositions and/or of a predetermined quantity of contents from at least two pressurized container.

### BACKGROUND OF THE INVENTION

Apparatus and method are available for releasing and substantially contemporaneously mixing content from two containers. The uses of such a system vary greatly and can include industrial processes requiring dispensing of a liquid from a container and adding and/or mixing the content in predictable and reproducible portions.

Separate storage and dispensing also proves advantageous for compositions that are not stable when combined and degrade when stored together. By combining and mixing the components of the composition immediately prior to use, degradation/oxidation/reduction/reaction is minimized. Moreover in the case of foam, by deferring application/mixing to the last moment before use its stability and quality are maximized and conversely reduction in stability and quality are minimized.

Although several methods of releasing and mixing liquid from two containers are known in the art, methods and apparatus for either releasing a predetermined amount of foamed content from at least one of two pressurized containers or substantially contemporaneously mixing and/or combining foamed compositions presents a challenge.

While various methods of releasing and mixing compositions have been proposed, the mixing of foamed compositions is particularly challenging. Many configurations that propose to mix foam compositions result in reduced foam quality. The stability and quality of a foam may be adversely affected by the by-product of a reaction with another foam, which may materially affect the re-usability of the applicator for human or animal use. Configurations that have an internal mixing chamber and or a single outlet, for example, will after a first application contain both foamable compositions. One or more active ingredients and or excipients present in one foamable composition or foam can react with one or more active ingredients and or excipients in another foamable composition or foam. The by-product of such application may be undesirable and can contaminate the next application and may not be acceptable for pharmaceutical and cosmetic preparations for human or animal use. It is desirable to have a method, apparatus, system or kit which allows for repeated use without the foamable compositions or foam remaining in contact.

There remains a need for methods and devices that can substantially contemporaneously provide for the release and/or combination of compositions, especially from two compositions, being released from at least two containers such that the different foams do not remain in contact within the devices or kits following their release.

There also remains a need for methods and devices that will allow for quick and easy removal of any released foam from the area of the outlet(s) or provide for a disposable outlet end-piece (or possibly provide for rinsing by the outlet).

### SUMMARY OF THE INVENTION

A therapeutic kit is provided for releasing a predetermined quantity of a foamable composition from a plurality of pressurized containers

A dispenser head for use with a plurality of containers is provided for contemporaneously mixing and/or combining a plurality of foamable compositions.

The methods, devices and kits can contemporaneously mix and/or combine a plurality of compositions (with or without metered dosing). The methods devices and kits provide storage and release of multiple components of a therapeutic composition without a degradation of the cosmetic and/or pharmaceutical properties of the combined compositions.

In one aspect, there is provided a dispenser head for use with a plurality of containers, comprising:

(a) an actuator, wherein the dispensing head is structured and positioned to be an actuator or comprises an actuator button disposed within the dispensing head to simultaneously actuate the plurality of containers

(b) a flow guide comprising
a plurality of flow conduits disposed within the flow guide; and
for each of the plurality of flow conduits,
   an inlet through a wall of the flow guide connecting with a flow conduit; and
   an outlet from a flow conduit through a wall of the flow guide;
      and for each of the plurality of inlets and containers, a linker, each to link an inlet and a container to allow the contents of the container upon actuation to pass through the inlet and through the flow conduit to reach and pass through the outlet;
      and wherein the flow guide is structured and positioned to allow simultaneous flow communication between each of the plurality of flow conduits and wherein the plurality of outlets are structured and positioned to allow substantially contemporaneously dispensing and/or combining of the content from a plurality of containers external to the dispensing head.
      In an embodiment the linker is a hollow stem projecting out of a container and adapted to fit within the inlet through which the contents of the container are dispensed when the stem is activated,

In another aspect, there is provided a dispenser head for use with a plurality of containers, each of the containers having a hollow stem through which contents are dispensed when the stem is activated, comprising:

(a) a flow guide structured and positioned to receive a plurality of pressurized containers;

(b) a plurality of flow conduits disposed within the flow guide, each of the plurality of flow conduits comprising an inlet and an outlet and each said inlet capable of engagement with a hollow container stem through a hollow container stem; and

wherein the flow guide is structured and positioned to allow simultaneous flow communication between each of the plurality of flow conduits and a respective hollow stem, allowing substantially contemporaneously dispensing and/or combining of the content from a plurality of containers.

In one aspect, a dispenser head for use with a plurality of containers includes:

an actuator, wherein the dispensing head is structured and positioned to be an actuator or comprises an actuator button disposed within the dispensing head to simultaneously actuate the plurality of containers

a flow guide comprising

a plurality of flow conduits disposed within the flow guide; and

for each of the plurality of flow conduits,

an inlet through a wall of the flow guide connecting with a flow conduit; and

an outlet from a flow conduit through a wall of the flow guide;

and for each of the plurality of inlets and containers, a linker, each to link an inlet and a container to allow the contents of the container upon actuation to pass through the inlet and through the flow conduit to reach and pass through the outlet;

and wherein the flow guide is structured and positioned to allow simultaneous flow communication between each of the plurality of flow conduits and wherein the plurality of outlets are structured and positioned to allow substantially contemporaneously dispensing and/or combining of the content from a plurality of containers external to the dispensing head.

In one or more embodiments, the linker is a hollow stem projecting out of a container and adapted to fit within the inlet through which the contents of the container are dispensed when the stem is activated,

In one or more embodiments, each foamable composition/foam remains segregated from the other foamable compositions/ foams until they commence exiting through the outlets substantially simultaneously.

In one or more embodiments, any combining, interaction and or mixing substantially contemporaneously of the content from the plurality of outlet ports occurs substantially at a location external to the dispensing head.

In another aspect, a dispenser head for use with a plurality of containers, each of the containers having a hollow stem through which contents are dispensed when the stem is activated, includes:

a member structured and positioned to engage a hollow stem from each of a plurality of containers;

a plurality of flow conduits, each of the plurality of flow conduits comprising an inlet port and an outlet port and a connecting conduit between them defining a flow path and each said inlet port capable of flow communication with a stem of a container;

a flow guide accommodating at least a portion of each of said plurality of flow conduits, wherein said flow guide defines a flow direction at the outlet port for each said flow guide,

wherein each said flow conduit defines a segregated flow path such that mixing between different container contents is prevented prior to a substantially contemporaneously dispensing of the contents from the plurality of outlet ports to a location external to the dispensing head.

In one or more embodiments, the flow direction at the outlet ports facilitates combining, interaction or mixing substantially contemporaneously of the content from the plurality of outlet ports at a location external to the dispensing head.

In one or more embodiments, the cross-sectional areas of each of the plurality of flow conduits is substantially the same, or the cross-sectional area of at least one flow conduit is greater than those of the other plurality of flow conduits, or the cross-sectional area of one flow conduit varies along its length, or the cross-sectional area of the flow conduit increases along its length.

In one or more embodiments, the flow guide is rigid and is structured and positioned to engage a hollow stem from each of a plurality of pressurized containers.

In one or more embodiments, the flow guide defines a flow path between an inlet port on a first sidewall of the flow guide and an outlet port on a second sidewall of the flow guide, or the flow guide defines a flow path between an inlet port on a face of the flow guide and an outlet port on a sidewall of the flow guide.

In one or more embodiments, at least two flow conduits in flow communication with at least two pressurized containers, or three or more flow conduits in flow communication with three or more pressurized containers.

In one or more embodiments, a first flow conduit comprises a first outlet port and a first flow conduit comprises a first outlet port and said flow guide defines a flow path such that said first and second outlet ports are adjacent to one another.

In one or more embodiments, the flow guide defines a direction such that first outlet and said second outlet are positioned to direct container content towards one another so as to allow mixing at a location external to the dispenser head.

In one or more embodiments, the flow guide defines a flow direction such that outlets are positioned to direct container contents adjacent to one another at a location external to the dispenser head.

In one or more embodiments, the flow guide defines an angle of convergence the plurality of flow conduits, and the angle is in the range of 30° to 120°, or the flow conduits converge in a ‘v’ shape, or the flow path of the flow conduit through the flow guide is curvilinear, or the flow path of the flow conduit through the flow guide is linear.

In one or more embodiments, an applicator or spreader is connected to the flow guide at said plurality of outlet ports.

In one or more embodiments, the diameter of a first flow conduit is smaller than that of a second flow conduit and the first and second flow conduits are co-axial.

In one or more embodiments, each of the conduits describes a passageway of substantially the same cross sectional area

In one or more embodiments, the foam exiting the first flow conduit outlet is surrounded by a second foam exiting from the second flow conduit outlet wherein the first and second flow conduits are co-axial.

In one or more embodiments, the second outlet is adapted so that second foam is substantially directed at an angle into the first foam

In one or more embodiments, the outlets are adapted so that the second foam is substantially directed to the first foam and the second foam is in part substantially directed to the first foam

In one or more embodiments, a flow-controlling device is mounted between the flow guide and the actuator.

In one or more embodiments, an exit shield substantially surrounds said plurality of outlet ports.

In one or more embodiments, the member structured and positioned to engage a hollow stem is positioned substantially perpendicular to the container, or is substantially in plane with the container.

In one or more embodiments, the flow guide further comprises a rotatable disk housed within the flow guide, wherein the outlet ports are located in the rotatable disk.

In one or more embodiment, a portion of each flow conduits comprises an elongated conduit spanning said member and said flow guide, and the elongated conduit comprises a flexible tube

In one or more embodiments, the flow guide accommodates a portion of the elongated conduit at a location distal from the inlet port.

In another aspect, a kit for contemporaneously mixing and/or combining a plurality of foamable compositions, comprising a plurality of pressurized containers, each said pressurized containing comprising a foamable composition; and a dispenser kit substantially as described above.

In one or more embodiments, one or more container comprises:

a first foamable composition;

a first pressurized gas;

a first valve for releasing said first foamable composition from said first container;

a first metering chamber in fluid communication with said first container and said first valve, said first metering chamber having a first upper wall and a first lower wall and defining a volume proportionate to a predetermined quantity of said first foamable composition to be delivered; and

a first movable partition comprising a first seal located in said first metering chamber, said first movable partition capable of moving from a first resting position spaced apart from said first valve to a second sealing position in sealing arrangement with said first valve.

In one or more embodiments, a kit for contemporaneously mixing and/or combining a plurality of foamable compositions, comprises a plurality of pressurized containers, each said pressurized containing comprising a foamable composition; an actuator, wherein the dispensing head is structured and positioned to be an actuator or comprises an actuator button disposed within the dispensing head to simultaneously actuate the plurality of containers; a flow guide comprising a plurality of flow conduits disposed within the flow guide; and for each of the plurality of flow conduits, an inlet through a wall of the flow guide connecting with a flow conduit; and an outlet from a flow conduit through a wall of the flow guide; and for each of the plurality of inlets and containers, a linker, each to link an inlet and a container to allow the contents of the container upon actuation to pass through the inlet and through the flow conduit to reach and pass through the outlet; and wherein the flow guide is structured and positioned to allow simultaneous flow communication between each of the plurality of flow conduits and wherein the plurality of outlets are structured and positioned to allow substantially contemporaneously dispensing and/or combining of the content from a plurality of containers external to the dispensing head.

In another aspect, a therapeutic kit includes:

a dual aerosol dispenser including:

a first container including:

a first foamable composition comprising a therapeutically active agent;

a first pressurized gas;

a first valve for releasing said first foamable composition from said first container;

a first metering chamber in fluid communication with said first container and said first valve, said first metering chamber having a first upper wall and a first lower wall and defining a volume proportionate to a predetermined quantity of said first foamable composition to be delivered; and

a first movable partition comprising a first seal located in said first metering chamber, said first movable partition capable of moving from a first resting position spaced apart from said first valve to a second sealing position in sealing arrangement with said first valve; and

a second container including:

a second foamable composition;

a second pressurized gas;

a second valve for releasing said first foamable composition from said second container;

a second metering chamber in fluid communication with said second container and said second valve, said second metering chamber having a second upper wall and a second lower wall and defining a volume proportionate to a predetermined quantity of said second foamable composition to be delivered; and

a second movable partition comprising a second seal located in said second metering chamber, said second movable partition capable of moving from a first resting position spaced apart from said second valve to a second sealing position in sealing arrangement with said second valve.

an actuator attached to the stems of the first container and the second container for substantially contemporaneously mixing and/or combining the first foamable composition and the second foamable composition.

Methods are provided for substantially contemporaneously mixing and/or combining two compositions being released by providing a therapeutic kit as described substantially above and actuating said third valve for releasing the first foamable composition and the second foamable composition from the first and the second container.

Method of dispensing a foam are provided by providing a kit substantially as described above and displacing the member to actuate said plurality of stem valves, so as to dispense a plurality of foamed compositions along a plurality of substantially segregated flow paths such that substantially no mixing of container contents occurs prior to a substantially contemporaneously dispensing of the content from the plurality of outlet ports to a location external to the dispensing head.

In one or more embodiments, at least one of the plurality of foam compositions comprises a therapeutically effective agent.

Another aspect provides the use of the kit substantially as described above in the treatment of a disorder.

It will be more easily understood upon a thoughtful deliberation of the following detailed description of the embodiments of the present invention in conjunction with the accompanying drawings.

### BRIEF DESCRIPTION OF THE DRAWINGS

FIG. 1 is a cross sectional view of an apparatus for substantially contemporaneously releasing, mixing and/or combining at least two foamable compositions measure of content from at least two containers.

FIG. 2A is a top view of one possible embodiment of a dispenser head for substantially contemporaneously releasing, mixing and/or combining at least two foamable compositions from at least two containers according to the present invention.

FIG. 2B is a schematic perspective view of one possible embodiment of a dispenser head connected to a pair of containers for substantially contemporaneously releasing, mixing and/or combining at least two foamable compositions from at least two containers according to the present invention. The head and containers are accommodated in a housing.

FIG. 2C is a rear view of one possible embodiment of a dispenser head connected to a pair of containers for substantially contemporaneously releasing, mixing and/or combining at least two foamable compositions from at least two containers according to the present invention. The head and containers are accommodated in a housing.

FIG. 2D is a schematic perspective view of one possible embodiment of a dispenser head connected to a pair of containers for substantially contemporaneously releasing, mixing and/or combining at least two foamable compositions from at least two containers according to the present invention.

FIG. 3A is a schematic cross-sectional view of an interior of a dispenser head illustrating the location and angle of orientation of the flow conduits according to one or more embodiments of the invention;

FIG. 3B is a schematic cross-sectional view of a dispenser head illustrating the location and angle of orientation of the flow conduits that extend beyond the flow guide according to one or more embodiments of the invention;

FIG. 3C is a schematic view of an interior of a flow conduit terminating in a paddle according to one or more embodiments of the invention;

FIG. 3D is a schematic view of a dispenser head from below illustrating the location and angle of orientation of the flow conduits.

FIGS. 4A and 4B are perspective illustrations of (A) a kit assembly in which the dispensing head is in plane with the containers and (B) a kit assembly in which the dispensing head is perpendicular to the containers.

FIGS. 5A and 5B are (A) front and (B) rear views of a kit according to one or more embodiments of the invention.

FIG. 6 is a perspective drawing from below illustrating a dispensing head 600 designed to accommodate three canisters.

FIG. 7 is a schematic view of a dispenser head in which the dispenser head is perpendicular relative to attachable containers, and the angle of each outlet can be adjusted by means of a rotatable disk housed within the flow guide of the dispenser head.

FIG. 8 is a schematic view of a dispenser head in which the dispenser head is axial relative to the pair of containers, and the angle of each outlet can be adjusted by means of a rotatable disk housed within the flow guide of the dispenser head.

FIG. 9 is a schematic view of examples of various embodiments of outlet ports in an outlet wall face of a dispenser head including a spreader connected to and extending from the flow guide along the plane of the outlet wall face.

FIG. 10 is a cross sectional side view of a container with a metered dosing control, and which can be combined with one or more other containers and/or with a dispenser head to form a therapeutic kit of the present invention.

FIG. 11 is a cross sectional view of an additional embodiment of the apparatus for substantially contemporaneously releasing a predetermined quantity of content from at least one pressurized container as well as mixing and/or combining at least two foamable compositions from at least two containers.

FIG. 12A is a cross sectional view of coaxial conduits according to one or more embodiments.

FIGS. 12B and 12C are front views of coaxial conduits according to one or more embodiments.

FIG. 12D is a cross sectional view of coaxial conduits according to one or more embodiments.

FIG. 13A is a cross sectional view of coaxial conduits according to one or more embodiments.

FIG. 13B is a front view of coaxial conduits according to one or more embodiments.

FIG. 14A is a schematic perspective view of a dispenser head according to one or more embodiments.

FIG. 14B is an alternative schematic perspective view of a dispenser head according to one or more embodiments.

FIG. 14C is an alternative schematic perspective view of a dispenser head according to one or more embodiments.

FIG. 14D is an alternative schematic perspective view of a dispenser head according to one or more embodiments.

### DETAILED DESCRIPTION OF THE INVENTION

In one or more embodiments, the present invention relates to a method, apparatus and kit to dispense at least two foamable compositions from at least two containers, one or both of which may be adapted to provide a metered dose. The composition may be the same or different.

In one or more embodiments, the present invention relates to a method, apparatus and kit that are adapted and suitable for the dispensing of at least two foamable compositions from at least two containers, one of which comprises a substance that is capable with reacting with another substance present in another container and therefore, which ideally are better kept apart, until such time as they are required for application.

In one or more embodiments the present invention relates to a method, apparatus and kit that are adapted and suitable for repeatedly dispensing at least two foamable compositions from at least two containers one of which comprises a substance that is capable with reacting with another substance present in another container and therefore, which ideally are better kept apart, until such time as they are require for application.

In one or more embodiments, the foamable composition comprises one or more of an active ingredient, a solvent or carrier, propellant and an excipient commonly used in topical, mucosal or dermatological applications, e.g., binders, antioxidants, buffering agents, colorants, emulsifiers, emission stabilizers, film formers, himectants, oxidizing agents, reducing agents, preservatives, emollients, sobars, surfactants, viscosity control agents, fragrance and like.

In general, any substance capable of using a foamable composition is contemplated in a famable composition or foam.

As noted above, certain components of a composition may be unstable or reactive in the presence of other components of the foam composition. Therefore, the components listed above may be contained in two or more containers so that reactive or unstable components do not contact or intermix prior to application.

By “reactive or reacting” any form of interaction or reaction is contemplated and may benefit from the apparatus and kits according to one or more embodiments, including without limitation oxidation/reduction/chemical reaction/photo reaction/degradation/crystallization/precipitation/binding/de-stabilization/affecting foam quality/affecting foam density/affecting foam viscosity/affecting foam stability/affecting foam breakability/affecting foam color, etc. or any other physical characteristics of a foam.

Whilst the present invention is adapted and suitable as aforesaid it can equally well be used for compositions which are compatible with each other without containing a substance that is capable with reacting with another substance. The present invention may also be used with the same compositions, for example, to simply provide a double metered dose in one application.

A dispenser head capable of dispensing and/or combining at least two foamable compositions from at least two containers includes a flow guide structured and arranged to receive a plurality containers, a plurality of flow conduit positioned, at least in part, inside the flow guide and an actuator that initiates material flow from the containers through the flow conduits. The containers can be pressurized and provided with valves that are opened by actuating hollow stems through which the container foamable contents are dispensed.

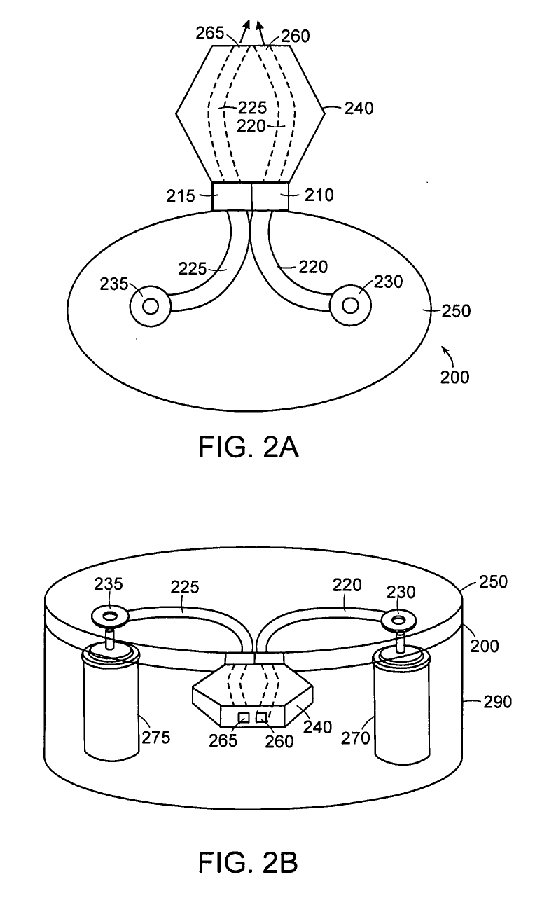

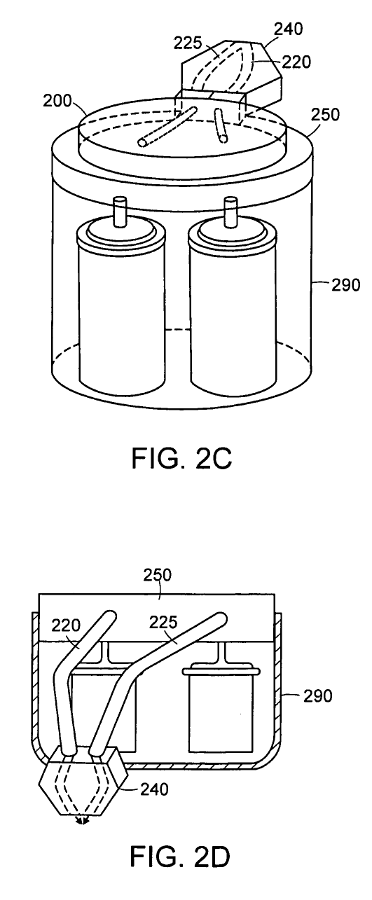

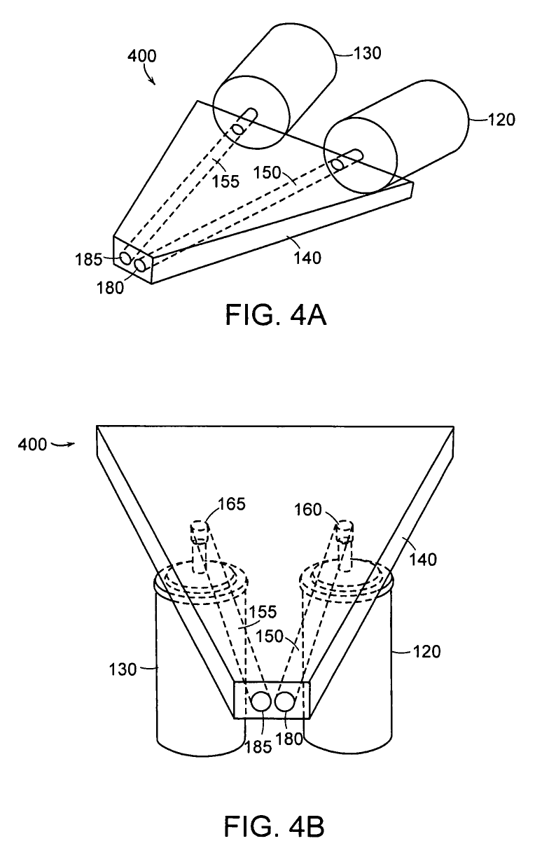

An actuator is a mechanism or structure that puts something into action. The actuator in each case acts on the stems of the containers to open the valve(s). In one embodiment, the flow guide and the actuator comprise a single unit (see, e.g., FIG. 4B). In another embodiment, the dispenser head includes a separate member that serves, at least in part, as an activator, and a flow guide (se, e.g., FIGS. 2A-2D). In yet another embodiment, the head itself could contain an actuator which could amount to one or more aerosol buttons linked together by a linking means which sit within the body of the head above the stems of the containers. The actuator may be operated mechanically or electronically.

The flow guide is a component of the dispenser head. The flow guide includes a plurality of flow conduits or at least a portion of flow conduits. The flow guide is capable of engaging with the dispensing end of the plurality of containers from which the hollow stems project. Each flow conduit includes an inlet that is adapted to engage with the hollow stem of a container. In some embodiments, the conduit is directly, sealingly engaged with the container stem. In other embodiments, the conduit may be spaced apart (but in flow communication) with the stem. An actuator may be interposed. The actuator is structured and arranged so that driving it toward a dispensing position causes displacement of the stems to initiate simultaneous dispensing of the container contents. When each of the stems are simultaneously actuated, the content in each container is simultaneously dispensed into a respective flow conduit through the respective engaged inlet port. The outlet port directs the dispensed content out of the each flow conduit to a location external to the flow guide where they may combine, interact and/or mix.

The terms “content” or “foamable composition” as used herein, shall include but will not be limited to any foamable substance or composition, including any foamable emulsion, any foamable solution any foamable suspension, any foamable gel, any viscous material, any extrudable material and any gel. The “content” or “foamable composition” may include components which, individually or in combination “are useful as a cosmetic, or pharmaceutical carrier.” The “content” or “foamable composition” may further include an active agent, as is described in greater detail below. The contents of the containers may include one or more of the following: (a) an active ingredient; (b) an excipient; (c) a solvent or carrier; (d) a propellant; (e) a surfactant; (f) an adjuvant; (g) a polymeric agent; (h) a buffer; (i) a stabilizer; (j) a preservative; (k) a benefit agent/or any other substances which may be suitable for inclusion in a pharmaceutical or cosmetic composition.

The dispensing head can be combined with a plurality of containers to provide a kit capable of dispensing and mixing a plurality of foamable compositions. The kit may include a supportive or protective housing that contains the containers and assists in securing the dispensing head on the containers.

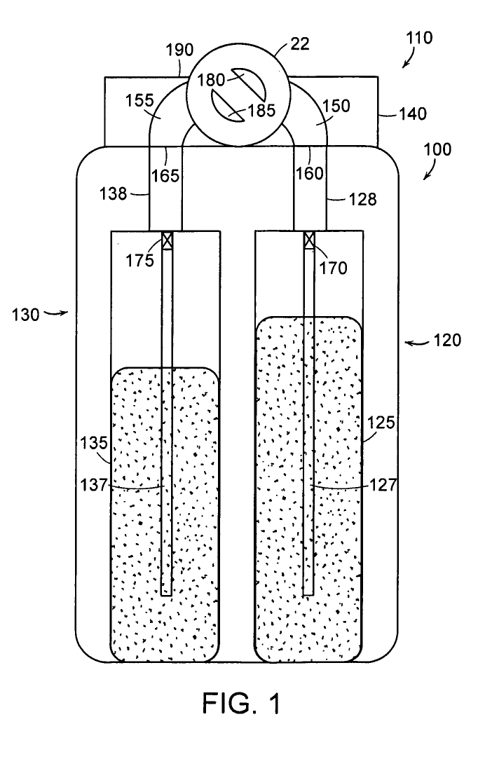

Turning now to the drawings, FIG. 1 shows a kit 100 including a dispenser head engaged with a pair of pressurized containers 120, 130. It will be apparent from the description herein that the kit may designed to accommodate any number of containers; however, for the purpose of illustration, a two-container embodiment is shown. This is not intended to be limiting of the invention.

In one embodiment, FIG. 1 shows in cross-section a kit 100 including a dispenser head 110 mounted on two containers 120 and 130 containing contents 125 and 135 for dispensing and mixing. The dispenser head and the containers are accommodated in a housing. The dispenser head 110 includes a flow guide 140, which also functions as an actuator. Flow guide 140 houses a flow conduits 150, 155, whose function is described in greater detail below. The cross-sectional area of each conduit may be the same or different. The container contents include a foamable composition that is flowable, e.g., a fluid, a liquid and a semi-liquid. Container 120 has stem 128 that extends from container 120 and engages with fluid conduit at an inlet 160. Similarly, container 130 has stem 138 that extends from container 130 and engages with fluid conduit at an inlet 165.

Each container 120 or 130 in the embodiment described is of the pressurized aerosol can type and has its own internal valve (170, 175) fitted with a valve stems 128, 138, respectively. Container 120 includes a hollow tube 127 that is attached to or integrally formed with, a internal valve 170, thereby readily facilitating flow of liquids, fluids and gas through tube 127 through valve 170 and into stem 128. The stem 128 is hollow and depressing the stem opens the valve so that the container contents are dispensed through the hollow stem. Similarly, container 130 includes a hollow tube 137 that is attached to or integrally formed with, a internal valve 175, thereby readily facilitating flow of liquids, fluids and gas through tube 137 through valve 175 and into stem 138. The stem 138 is hollow and depressing the stem opens the valve so that the container contents are dispensed through the hollow stem. The valve in some types of containers includes a return spring for returning the stem to its initial position so as to close the valve when the force depressing the stem is removed.

Flow guide 140 has a pair of flow conduits 150, 155, each defined by a tubular wall having an inlet 160, 165, respectively, and an outlet 180, 185, respectively. Inlets 160, 165 of flow conduits 150, 155 abut of the upper ends of stems 128, 138 respectively, when the containers 120, 130 are fully mounted on the dispenser head 140. When the flow conduits 150, 155 are in place in the flow guide 140, outlets 160, 165 are positioned coaxial with the respective container stems 128, 138.

The foamed material exits from outlets 180, 185, where it is combined and/or mixed. The position and location of the outlets can be adjusted to obtain the desired degree of combining and/or mixing. Because the individual foamed components do not mix inside the dispenser head, the foam is able to expand to its optimal extent. Furthermore, the outlets are positioned to achieve a reasonable, good or high degree of combination/mixing/interaction without loss or substantial loss of foam quality.

The dispenser head of the current invention is advantageous compared to the prior art dispensing apparatus, in which some mixing occurs within the apparatus and/or end nozzles attached to the apparatus, thereby resulting in contamination and/or requiring disposal of the end nozzles and/or cleaning of some or all of the apparatus.

The dispenser assembly 140 is used as follows. The user attaches appropriate containers 120, 130 onto the dispensing head. The containers may contain the some or different contents. In one or more embodiments, the contents may include a cosmetic and/or pharmaceutical carrier, and/or an active agent. The carrier may be in each of the containers, or may be obtained upon mixing of the contents of two or more containers. In one embodiment, one or more containers may include a cosmetic and/or pharmaceutical carrier and an additional container may include an active therapeutic or cosmetic agent. To start dispensing the container contents, the user activates the valve stems, causing the flow conduits 150, 155 to move down, thereby pressing the stems 128, 138 downward and opening the valves 170, 175 of containers 120, 130, respectively. In this embodiment, activation occurs by pressing on an upper surface 190 of the Flow guide to displace the flow guide towards the stems.

Alternatively, a separate member of the dispensing head may serve as the actuator, so that when the user presses against an upper surface of the dispenser, the dispenser head is displaced downwards and against the upper stems of the containers. Other levers, buttons or switches may be provided to actuate the kit.

When the actuator is at rest, stems valves 170, 175 are sealed, causing the container contents to remain in the pressurized containers 120, 130. When the actuators is activated, the stem 128, 138 are pressed downwards causing stem valves 170, 175 to open and the container contents to be released. The contents flows through stems 128, 138 to inlets 160, 165 and into flow conduits 150, 155. The contents then reaches outlets 180, 185, so as to be dispensed. Thus, the flow guide includes a plurality of exit ducts that release foamed content from their respective containers such that the contents are substantially contemporaneously mixed and/or combined at a location external to the flow guide.

By a location external, this means at an area or space that is at a point of exit, that is at a point of reference just or somewhat beyond the point or exit or that is at a point of reference just before a point of exit (for example, the latter may apply where the ends of the exit conduits are formed at an angle).

It is also envisaged that the container can be a non aerosol mechanical foamer. By way of a non-limiting example only, such a non aerosol mechanical first foamer container can include non aerosol mechanical foamers as disclosed in any of U.S. Pat. Nos. 4,018,396; 4,440,320; 4,603,812 and 4,738,396 all of which are hereby incorporated in their entirety by reference.

In an embodiment where it is intended that the canisters and head are to be operated in an inverse position, the hollow tubes 127,137 of FIG. 1 may be provided inverted substantially in the shape of a “U” wherein the inlet end of the hollow tubes 127,128 for the composition is submerged below the surface of the composition when the canister is inverted.

The dispensing head may be detachable from the canisters, or it may be permanently attached. In detachable embodiments, outlets 160, 165 abut or sealably contact container stems 128, 138, respectively. In disposable embodiments, outlets 160, 165 may be integral with container stems 128, 138, respectively.

FIG. 2A illustrates a dispensing head 200 according to one or more embodiments of the invention including a member separate from the flow guide for activation of the head. Dispenser head 200 includes member 250 and flow guide 240. The member includes a first inlet 230 and a second inlet 235, a portion of first flow conduit 220 and a second conduit 225. The flow conduit may be secured to or embedded in member 205. The flow conduit may span the member between the inlet ports and connectors. The flow guide includes a first outlet port 260 and a second outlet port 265, and a portion of the first flow conduit 220 and the second fluid conduit 225. Connectors 210 and 215 join the flow guide 240 and the member 250, while accommodating conduits 220 and 225.

FIG. 2B illustrates a kit incorporating dispenser head 200 is joined to containers 270 and 275. In an illustration, the dispenser head and the containers are accommodated within a housing XXX for support and ease of handling and/or for improved rigidity and stability. The member 250 serves as a lid or cover for housing 290. The member 250 also functions as an actuator, when pressed against the stems of containers 270 and 275, for releasing a first foamable composition from the first container 270 via the first inlet port 230, the first conduit 220, and the first outlet port 260; and a second foamable composition from the second container 275 via the second inlet port 235, the second flow conduit 225, and the second outlet port 265 outlet port, such that the two compositions are substantially contemporaneously combined and/or mixed and/or interact at a location external to the flow guide 240. Although the containers are shown spaced fairly far apart, it is contemplated that they may also be much closer or adjacent or abutting one another. The container and dispenser head may be accommodated in a housing 290, for improved rigidity, storage, handling and stability.

FIG. 2C shows a rear view of one possible embodiment of a dispenser head connected to a pair of containers for substantially contemporaneously releasing, mixing and/or combining at least two foamable compositions from at least two containers according to the present invention. In the illustration the dispenser head and the containers are accommodated within a housing XXX for support and ease of handling or for improved rigidity and stability. In view is a an actuator button XXX disposed within the dispensing head which when depressed acts on the hollow stems of he containers to open a valve in the container and release foamable composition as described elsewhere herein.

FIG. 2D illustrates a schematic perspective view of another possible embodiment of a dispenser head connected to a pair of containers for substantially contemporaneously releasing, mixing and/or combining at least two foamable compositions from at least two containers according to the present invention. In this embodiment, flow guide 240 is not secured to member 250 and a portion of the flow conduit spans the two elements.

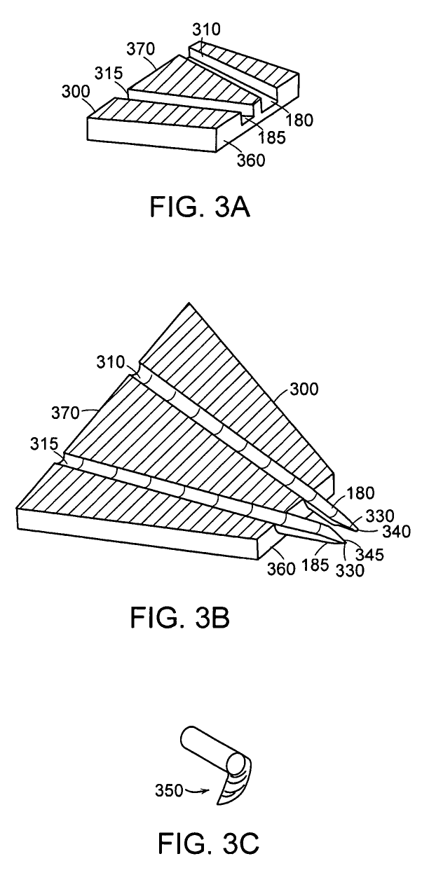

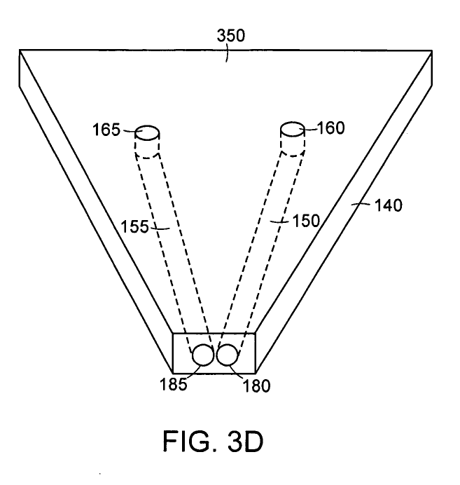

Further embodiments of the dispenser head and related kit are shown in FIG. 3A-3D. FIGS. 3A and 3B shows a cross-sectional view of the flow guide interior, illustrating various embodiments of the invention.

In one or more embodiments, the flow guide is flexible and can be, for example, a flexible tube. The placement of the flow guide in FIG. 2D allows the user to manipulate the flow guide for better positioning and release of foam to a target site.

In FIG. 3A, the flow conduits are embedded in the dispensing head. In one or more embodiments, the flow conduits converge at the outlet ports 180, 185. Note that in FIG. 3A, the two outlet ports are spaced apart from one another; the actual spacing can vary. In exemplary embodiments, the outlet ports are spaced apart from one another a distance of about _{—}˜0 to ˜2.5 cm and in particular about _{—}˜1_ to ˜7 mm. In FIG. 3A, the flow conduits are embedded in the dispensing head. In one or more embodiments, the flow conduits converge at the outlet ports 180, 185. The angle of convergence, e.g., the angle between the two conduits, is selected to direct the foamed contents towards one another as the foamed contents exit the flow guide. In some embodiments, the outlet port may abut and touch one another. The angle of convergence, e.g., the angle between the two conduits, is selected to direct the foamed contents towards one another as the foamed contents exit the flow guide. The convergence angle can range between 0 to 180 degrees; between about 5 to about 165 degrees and in particular can be about 15 to about 120 degrees. The preferred angle may vary according to a number of factors including without limitation the foamable composition, the propellant, the target area, the field of application, the subject of application and the length and form of conduit and the form of outlets.

The shape and angle of the flow conduits may vary in order to vary the distance between the points of exit of each foamed composition. In one or more embodiments, the flow conduits within the flow guide together have a substantially convergent “v” formation, as illustrated in FIGS. 3A and 3B. In other embodiments, the flow conduits within the flow guide can have a “u” configuration, in which the conduits take a more organic, non-linear pathway to the exit point, but nonetheless exit at substantially the same point (see, e.g., FIGS. 2A and 2B in which it can be seen that the direction of the pathways at the exit point describe an angle of convergence). FIG. 3D illustrates an embodiment of the dispensing head in which the flow conduits are positioned to abut or contact one another at the outlet port. Note the different orientation of the flow conduits, having inlet ports on a face 350 of the flow guide and outlet ports in a sidewall.

As shown in FIG. 3A, the dispensing head includes 350 of the flow guide flow guide 300. As exemplified in FIG. 3A, the flow guide 300 is made of molded plastic and the molded flow conduits 310, 315 are integral to the flow guide 300, and outlet ports 180 and 185 terminate on a sidewall 360 of the flow guide 300. In this current embodiment, the inlet ports are located on sidewall 370, where sidewalls 360 and 370 are on opposing sides of the flow guide. In other embodiments, the flow guide may form a hollow frame and/or the flow conduits are made from flexible or rigid tubing. Suitable materials for the flow guide and tubing include any types of materials usually used in or approved for an apparatus or kit for dispensing pharmaceutical and cosmetic compositions. These materials are selected so that they are suitable for reasonable term storage of the composition taking into account the components of the composition. Suitable materials include, without limitation, plastics, perspex, metals alloys, wood and other natural or synthetic polymers.

FIG. 3B is another embodiment of the flow guide 300, in which the flow conduits are embedded in the dispensing head. As shown in FIG. 3B, the outlet ports 180 and 185 extend beyond the sidewall 360 of flow guide 300 and direct the exiting foamed contents to a specific location external to the dispensing head. The angle of convergence, as discussed above for FIG. 3A, is selected to direct the foamed contents towards one another as the foamed contents exit the flow guide.

The outlet ports 180, 185 also may be of different shapes that facilitate the dispensing, mixing and/or spreading of the foamed composition. In FIG. 3B, the outlet ports 180 and 185 terminate in a point 330 and the terminus forms a diagonal face 340, 345. The open faces 340, 345 are directed towards each other so that the exiting foam contents are directed towards each other. FIG. 3C illustrates a further embodiment of the flow conduit 330, in which the terminus of the outlet port includes a paddle 350 that can be used to direct, mix or spread the exiting foam. Note that size, angle and paddle shape can assist with external combination and application of the foams. The paddle can be of various sizes and shapes and set at various angles and configurations to facilitate the exit path, combination/interaction, application and/or spreading of exiting foam(s).

FIGS. 4A and 4B illustrate the positioning of the containers and the dispensing head in a kit according to one or more embodiments.

In an embodiment according to FIG. 4A, the containers are located in the same plane as the dispensing head 400, and the flow conduits also lie in the same plane. The inlets 160, 165 are located along a sidewall of the flow guide; flow conduits 150, 155 traverse the plane of the flow guide to the outlet ports 180, 185 in an opposing sidewall. In one or more embodiments, a frame (not shown) may be provided to support the containers and maintain alignment of the kit components.

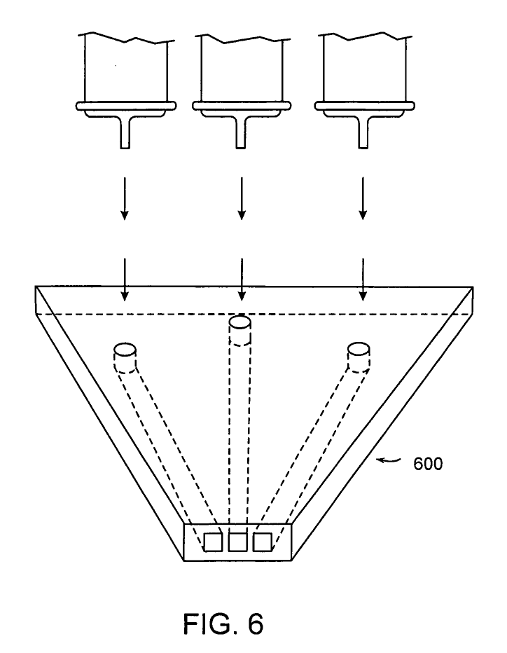

FIG. 4B shows a kit including a dispenser head 405 joined to a pair of containers 120, 130, in which the flow guide 140 is perpendicular to the containers. In this embodiment, inlets 160, 165 are located on a face 400 of the flow guide. The inlet conduits include an entry portion 410, 415 that is approximately perpendicular to the plane of the flow guide and a planar portion 420, 425 that is in plane with the flow guide. The planar portion of the flow conduit continues to outlet ports 180, 185. This kit arrangement can be actuated by depressing the upper surface of the dispensing unit. FIGS. 3D and 6 also show the dispensing head in a view from the underside of the flow guide block, in which inlets 160, 165 in face 450 are clearly shown.

In a simple form of the invention the flow guide and actuator comprise a single unit, for example, FIG. 4B illustrates that the head is both a flow guide for the two canisters and also acts as an actuator. By pressing down on the head somewhere between the area between points 160 and 165 from above this will push down the stems at the top of the canisters and open the valves in each canister thereby releasing foamable compositions into two separate flow conduits exiting at points 180 and 185 respectively such that combination, interaction or mixing can only take place at an external location.

Note that the drawings are illustrative and may not be to scale and the dispensing head may be smaller (or larger) than shown. The cross section of the flow conduits may vary and may be larger or smaller. It may be substantially constant or alternatively, for example, be in the form of a funnel, or in a spiral or such other shape that suits the purpose of the conduits. The size of the dispensing head and the length of the flow conduit may vary to provide the appropriate convergence angle for the foam release. As the head size decreases, the flow conduit length also decreases and the convergence angle may increase.

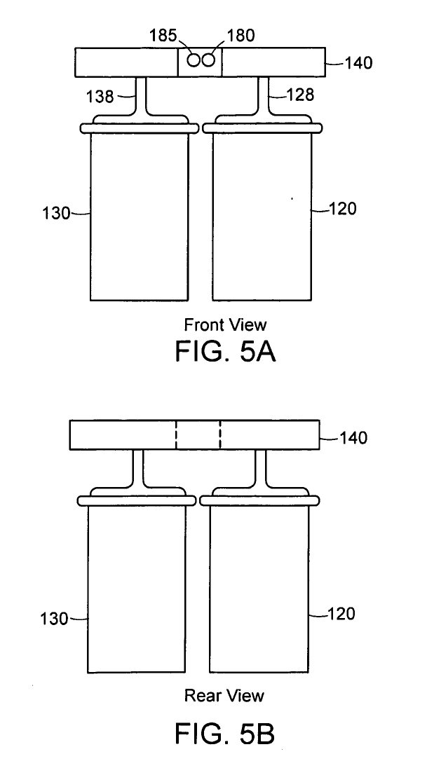

FIGS. 5A and 5B show a front and rear view of the assembled kit, respectively. The dispenser head is perpendicular relative to the pair of containers. In one or more embodiments, the dispenser head is oriented at an angle with respect to the containers that ranges from about 15° to about 180°.

FIG. 6 is a perspective drawing illustrating a dispensing head 600 designed to accommodate three canisters. The dispenser head is approximately perpendicular to the three containers, and each of the three outlets is separated in space. Alternatively, each of the outlets can be adjacent and/or abutting each other (without contact prior to dispensing the foam).

The dispenser heads and containers displayed in any of the embodiments and in particular as disclosed in FIGS. 4-6 can be mounted in a housing as described in FIG. 2B.

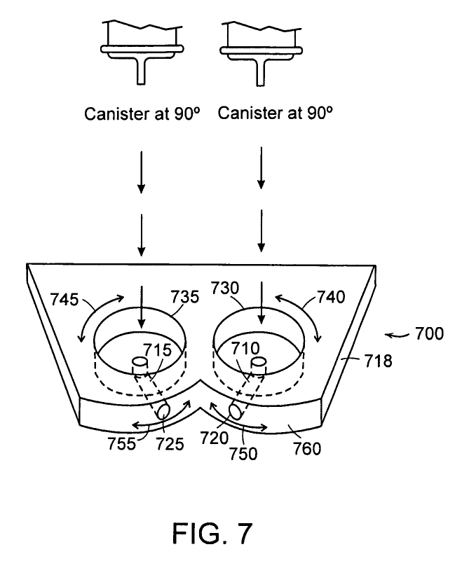

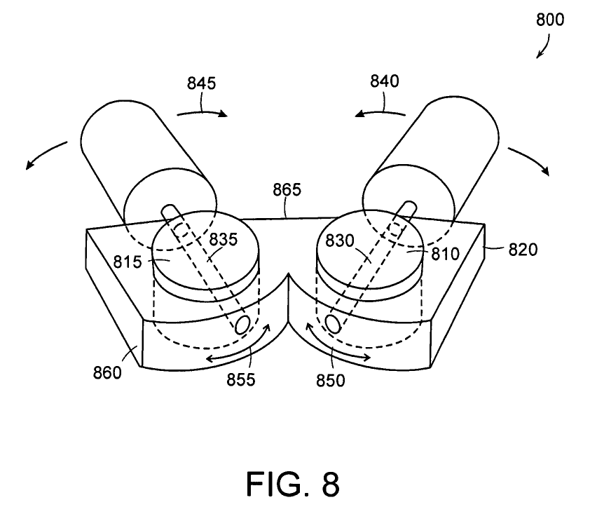

In one or more embodiments, the flow path and/or exit angle for one or more flow conduits is adjustable. FIG. 7 is a schematic illustration of an adjustable dispenser head 700 including flow guide 718, in which the positions of flow conduits 710, 715 and the accompanying outlets 720, 725 are adjustable by means of rotable disks 730, 735. The embodiment shown may be used where the dispenser head is positioned perpendicular to the canister. FIG. 7 provides a view from the underside of the dispensing head. According to one or more embodiments, the flow conduits are contained within rotating disks that are fixed within the flow guide block. The rotating disks are capable of movement in the directions indicated by arrows 740, 745 in FIG. 7. Each disk may rotate along the full exit face of the head in FIGS. 7 and 8 which is about up to 105 degrees preferably up to about 90 degrees. The sidewalls of the flow guide and of each rotating disk are adapted to maximize the possible variation in convergence angle that can be described between two theoretical lines extending along the direction of the exit positions. In other words, to maximize the range of exit angles described by each disk.

The disk and the surrounding circular base in which the disk sits can be connected for example by a male and female coupling around part or most of the circumference of the disk and circular base. The disk e.g. could provide the male coupling extending in the form of a narrow disk around its own circumference (except in the area of the conduits) wherein the narrow disk fits into a female coupling in the circular base and allows it to rotate about its own axis. Any forms of coupling as are known in the art may be suitable.

Rotation of the disk changes the exit position of the outlet ports 720, 725 within an arc along sidewall of the flow guide indicated by arrows 750, 755. The canister stem connects directly to the entry port in the center of the disk and the canister rotates with the disk. The entry point of the flow conduit (which is connected to the canister) is located in the center of the disk so that the canister, when engaged, can rotate about its own axis and is not displaced significantly when the disk is rotated. The disk can be rotated simply by adjusting the position of the canister. When the desired position is attained, the rotating disk is locked into place. The disk can be rotated by moving a flow guide located on the upper surface (not shown) or by simply twisting each canister into the desired position. The sidewall 760 containing outlet ports 720, 725 for the flow conduits 710, 715 may be curved to accommodate the curved surface of the rotating disk, as is shown in FIG. 7.

FIG. 8 illustrates the use of rotatable disks 810, 815 in a kit assembly 800 in which the containers and the dispenser head are in the same plane. In one or more embodiments, rotating disks 810, 815 substantially spans the width of the flow guide 820 and flow conduit 830, 835 traverse the diameter of the rotatable disk. The rotating disk is capable of movement in the directions indicated by arrows 840, 845 in FIG. 8, and both the canisters and the outlets are positionable within an arc defined by arrows 850, 855 along sidewall 860 of the flow guide. A rear sidewall 865 accommodates the inlet ports that connect to the stem of the canisters; and the front sidewall accommodates the outlet ports from the flow conduits. The sidewall containing outlet ports for the flow conduits may be curved to accommodate the curved surface of the rotating disk, as is shown in FIG. 8 and also to maximize the range of exit angles described by each disk.

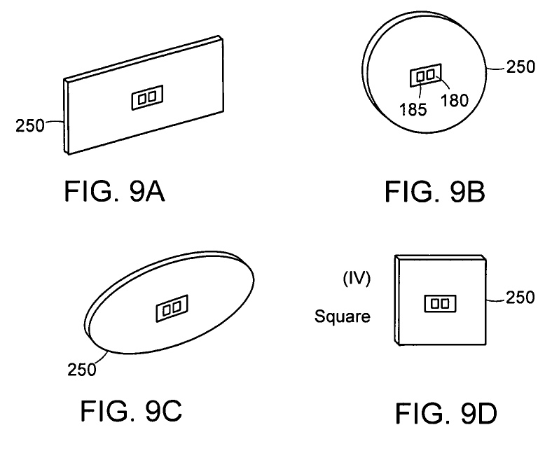

In one or more embodiments, the dispenser head is a spreader 250 is attached to or integrally formed with a dispensing head for easy application of the dispensed foam composition, as is shown in FIG. 9. Spreader 250 is used to apply a foam on the intended surface. It can be used equally well with a single or with a combined and/or mixed foam and reference to foam herein will include as appropriate all the different types of foam and combinations thereof. The spreader can be permanently or detachably fixed about an outlet part. The spreader substantially surrounds one or more outlet part of the dispenser head.

Spreader 250 is characterized by a feature selected from the group consisting of: a resilient characteristic, a semi-resilient characteristic, a pliable characteristic, a soft characteristic, a vulcanized material characteristic, a rubber characteristic, a silicone characteristic, a polymer characteristic, a plasticized material characteristic and a smooth characteristic. The spreader may have smooth rounded edges and corners for application to the target area as illustrated in Figures B and C.

Spreader 250 can be readily used to assist the application of foam to any desired surface including, but not limited to, any area afflicted by a disease, abnormality, cut, wound, pathogen, bacillus, virus, bacterium, micro-organism, infection and ailment. As such, spreader 250, can readily assist in smooth even application of the foamable composition. In employing spreader 250, the user does not need to use a hand or a finger to apply the foamed and mixed composition, which may be desirably for both for hygienic, esthetic or comfort reasons.

Clearly, if the foamed composition is to be applied to an intimate area of the body or an orifice of the body, the user will often prefer not to have to use their hands or finger. By way of example only, a focus group of mothers has expressed the view that applying material to baby's behinds is an unpleasant task when performed with their uncovered hands. Thus, use of a spreader to apply material in such a fashion readily alleviates such concerns as those raised by the mother's focus group. Furthermore, it may be advisable to avoid direct personal contact with sterile or other medicated compositions, so that use of a spreader is especially preferred.

In an embodiment, the spreader can be contoured in, for example, a convex or concave or other shape which will facilitate application to a target area.

It is envisaged that spreader 250 can be attached to, or integrally formed with, any foam flow guide and/or retrofitted to any existing foam kit.

The spreader in a preferred embodiment will have smooth rounded ends and corners suitable for application to a target area.

In one or more embodiments, the spreader is disposable.

In one or more embodiments, the spreader is sterile.

In another embodiment, the foam may be dispensed using two or more applicator stages. For example, the foam can exit the dispensing head in a predefined sequence, e.g., foam from canister 1 is delivered first and foam from canisters 2 and 3 are delivered together in a second stage. An illustrative example of an application is the delivery of a sterile cleanser to a locations, followed by active foams, e.g., foams containing therapeutically active agents, and then followed by a protecting foam, e.g., a foam containing protective lotions or emollients.

In one or more embodiments, the dispensing head is made available in different sizes to accommodate containers of different sizes. The head may be adaptable to fit containers of different sizes, for example, by use of housing that can secure the containers and the dispensing head, for example, with an adjustable ring. In one or more embodiments, the dispensing head is sterile. In one or more embodiments, the dispensing head is disposable; in other embodiments, the head is reusable. The canisters may be adapted for use in the upright or inverted position.

In one or more embodiments, it may be desirable to administer a carefully measured dose of a foamed composition from one or more canisters.

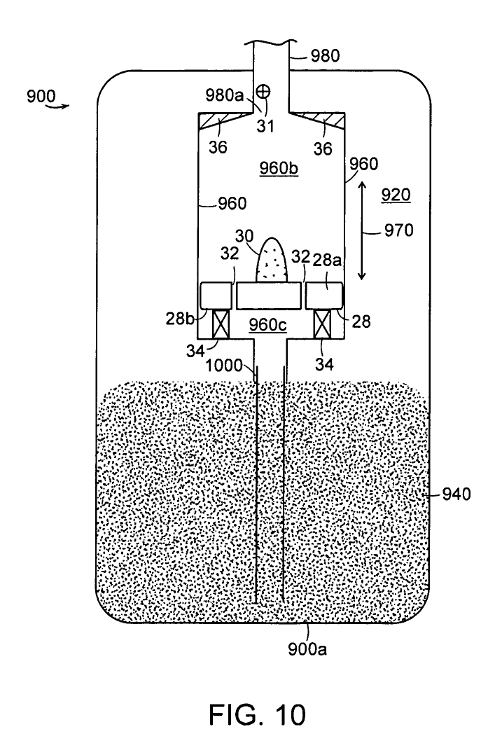

FIG. 10 [The figure will be renumbered to be consistent with the text. Text may need proofing to avoid redundant numbering] shows a container with a metered dosing control, and the container can be combined with one or more other containers and/or with a dispenser head to form a therapeutic kit of the present invention. Specifically, FIG. 10 shows a container 900 including content 940 under pressure created by gas 920. The container 900 is hollow body which may be made from any material, for example, aluminum, tin-plate, plastics including polyethylene terephthalate (PET), oriented polypropylene (OPP), polyethylene (PE) or polyamide and including mixtures, laminates and the like. When the container is metal, the interior surface of the metal container preferably is laminated with a plastic material or coated with a lacquer or with a varnish to protect the interior surface of the container from corrosion. Corrosion may weaken the container and may also lead to a discoloration of the container's content. Preferred plastic materials for lamination and lacquers or varnishes for coating are epoxy phenolic, polyamide imide, organosol, PET, PP, PE or a combination thereof.

Content 940 is flowable and can be a liquid or a semi-liquid. Content 940 includes components to provide the desired functionality of the foam upon administration, as well as additives that promote foam formation, such as surfactants and propellant. Aerosol propellants are used to generate and administer the foamable composition as a foam. The content may include a foamable emulsion, a foamable solution, a foamable suspension, a foamable gel, a viscous material, an extrudable material or a gel. The total composition including propellant, foamable compositions and optional ingredients is referred to as the foamable carrier. The propellant makes up about 3% to about 25 wt % of the foamable carrier. Examples of suitable propellants include volatile hydrocarbons such as butane, propane, isobutane or mixtures thereof, and fluorocarbon gases. In one or more embodiments, the propellant is a liquefied gas, such as butane, propane, isobutane or mixtures thereof. The liquefied gas typically forms a solution or emulsion with the other components of content 14 and is in equilibrium with propellant gas, which occupies a volume of the container (e.g., the “head space”) and generates the internal pressure used to discharge the product from inside the container. Furthermore, the gas expands to form many “bubbles” within the composition thereby creating the foam. Sufficient gas is contained in the container to substantially expel all the product from the container at the correct pressure throughout the life of the article. The quantity also depends from the type of gases used.

Container 900 further includes an integrated metering system including a metering chamber 960 in fluid communication with an upper conduit 18 and a lower conduit 1000. Chamber 960 can be of any shape, e.g., of circular, rectangular, or oval cross-section or the like, and can be attached to or integrally formed with the upper 980 or lower 1000 conduits, or both. Chamber 960 is selected to have a volume can hold and deliver a preselected quantity of content 940. Chamber 960 may contain shoulders 36, as is discussed in greater detail below. Alternatively, the chamber walls may be shaped to provide the desired interior volume and geometry. Chamber 960 and shoulder 36 may be constructed of a resilient material or a semi-resilient material, such as a vulcanized material, a rubber, a silicone, a polymer and a plasticized material.

Lower conduit 1000 is immersed in or in fluid communication with content 940, thereby readily facilitating flow of liquids, fluids and gas from the interior of the container 900, into lower conduit 1000 through chamber 960, and into upper conduit 980. In order to deliver the majority of the content from the container, the lower conduit 1000 extends a distance below chamber 960, and in some embodiments, a distance into the region of container where content 940 resides. In some embodiments, the lower conduit 1000 extends substantially to a floor 1000a of container 900.

Upper conduit 980 includes bleed hole or unidirectional valve 31, which is located in a wall portion of conduct 980 that is housed within the container and which provides one-way fluid communication between the container interior and the upper conduit. Fluid and gas are thus capable of flowing from the container and into upper conduit 980.

In order to control the dose size and its delivery from the chamber, movable partition 28 is slidably positioned within chamber 960 and is of a size and shape that permits it to be positioned along an inner wall 960a of chamber 960. The movable partition 28 is capable of vertical movement/displacement along the wall of chamber 960 in a direction indicated by arrow 970 by application of suitable upward and downward pressures or by gravitational forces. Movable partition 28 may have sufficient specific weight to be capable of downward vertical displacement within chamber 960 against the resistance of content 940 having varying viscosity. As discussed below, such displacement may be aided by biasing element 34. Movable partition 28 may be constructed of a resilient material or a semi-resilient material, such as for example, a vulcanized material, a rubber, a silicone, a polymer or a plasticized material.

Movable partition 28 includes sealer 30 for substantially sealing upper conduit 980 at opening 980a. Sealer 30 may be constructed of a resilient material or a semi-resilient material, which may be the same or different from that of the movable partition. Sealer 30 may be integral with movable partition 28 or it may be attached to the movable partition, for example by co-extrusion, heat welding, adhesives or any other appropriate joining method. Sealer 30 and upper conduit 980 are positioned in vertical alignment of one another, so that sealer 30 can block or interrupt fluid communication between chamber 960 and upper conduit 980 when positioned against the lower opening 980a of the upper conduit 980.

Movable partition 28 includes at least one aperture 32 that provides a passageway or conduit between an upper region 960b and a lower region 960c of chamber 960. Aperture 32 facilitates movement of content 940 and gas 920 across or through movable partition 28 as the movable partition moves within chamber 960. The movable partition includes at least one and preferably a plurality of apertures 32. In one or more embodiments, at least 2 apertures, or at least 4 apertures or at least 8 apertures are used. Aperture size and number will vary depending on dispensing conditions, such as for example, the content viscosity and canister pressure. Optionally, apertures 32 may be configured as a matrix of apertures or in a geometric configuration resembling that of a sieve. Aperture 32 typically has a dimension inversely proportional to the pressure of gas 920 in container 900 and proportional to the viscosity of content 940. In one or more embodiments, aperture 32 may have a dimension substantially approximating 0.1%-3% of the surface area of movable partition 28. In certain embodiments, aperture 32 may have a dimension substantially approximating 1% of the surface area of movable partition 28. In one or more embodiments, a plurality of movable partitions may be used, and may include a variety of apertures 32, depending on the viscosity of content 14 and the pressure of gas 920 in container 900.

A biasing element 34 optionally may be attached to or integrally formed with movable partition 28 in order to provide an additional opposing force on movable partition 28 as it is displaced substantially vertically in chamber 960. Exemplary biasing means include springs that can be attached to a lower surface 28a of movable partition 28 or a weight (not shown) that can be attached to the upper (28a) or lower (28b) surface of the movable partition. Biasing means serves the additional purpose of keeping the movable partition in its rest position between dosing. This can be particularly helpful to avoid movement during handling.

The upper conduit 980 is in fluid communication with valve 26. Flow guide 22 is disposed between upper conduit 980 and valve 26. By applying an external pressure to flow guide 22, the flow guide moves between a first (open) and second (closed) position. In the closed position, the passageway between conduit 980 and valve 26 is blocked and contents of container 900 are isolated from the exterior. In the open position, valve 26 is in fluid communication with the container interior and the contents of container 10 may be dispensed from the container through valve 26.

Further detail can be found in co-pending U.S. application Ser. No. 11/406,133, filed Apr. 18, 2006, and entitled “APPARATUS AND METHOD FOR RELEASING A MEASURED AMOUNT OF CONTENT FROM A CONTAINER,” the entire contents of which are incorporated by reference.

The metered dose device may be used in the kits described herein. At least one of the containers may include a metered dose device. The device may be used to deliver a precise amount of foamed content from each container. Alternatively, it may be desired to deliver a precise dose from one canister, for example, when the canister contains a therapeutically active ingredient and it is desirable that an accurate dose be dispensed. The remaining container(s) may contain carrier, for which precise metering is not desired or required.

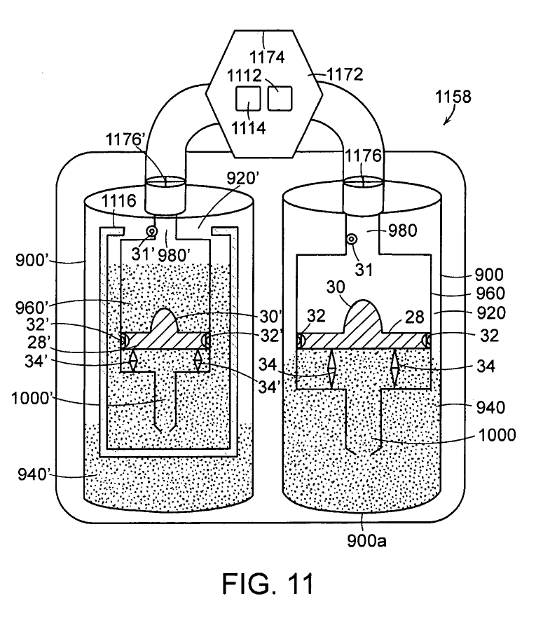

FIG. 11 shows an embodiment in which a kit 1158 includes a first container 900. First container 900 includes a first pressurized gas 920 and a first foamable composition 940 under pressure created by first gas 920 in first container 900. [This example will be reviewed and the numbering updated to make it consistent with the rest of the figures]

First foamable composition 940 has a characteristic selected from the group consisting of: a fluid, a liquid and a semi-liquid.

First container 900 preferably further includes a first chamber 960, wherein chamber is attached to, or integrally formed with, a first upper conduit 980 and a first lower conduit 1000, thereby readily facilitating flow of liquids, fluids and gas from first lower conduit 1000 through first chamber 960 and through first upper conduit 980.

First lower conduit 1000 is immersed in first foamable composition 940 such that first gas 920 readily displaces first foamable composition 940 through first lower conduit 1000 into first chamber 960 and through first upper conduit 980, pursuant to a user downwardly displacing a flow guide 1172, attached to or integrally formed with first upper conduit 980.

A user can readily release first foamable composition 940 from first container 900 by depressing an upper surface 1174 of flow guide 1172 thereby opening a first valve 1176 attached to, or integrally formed with flow guide 1172, such that flow of first gas 920 from first container 900 is readily facilitated, thereby bringing about a complimentary flow of first foamable composition 940 from first container 900 out through first valve 1176.

For the purpose of controlling the release of first foamable composition 940 from first container first valve 1176, a first movable partition 28 is situated in first chamber 960 such that upon first foamable composition 940 being displaced by first gas 920, a complimentary substantially upward vertical displacement of first movable partition 28 is brought about.

First movable partition 28 includes a first sealer 30 for substantially sealing first upper conduit 980 subsequently to first movable partition 28 being displaced upwards beyond a predetermined point.

First movable partition 28 includes at least one first release valve 31 formed in first movable partition 28 for readily facilitating bleeding of first foamable composition 940 and first gas 920 through first release valve 31 formed in first movable partition 28.

Thus, subsequent to a user depressing upper surface 1174 of flow guide 1172, first movable partition 28 is displaced substantially vertically upwards, within first chamber 960, by first gas 920 and/or first foamable composition 940 until first sealer 30 seals first upper conduit 980 or until the user releases flow guide 1172 thereby closing first valve 1176.

Thereafter, gravity applies a substantially vertical force on first movable partition 28. As such, first gas 920 and/or first foamable composition 940 “bleed” through first valve 31 formed in first movable partition 28, thereby readily facilitating substantially downward vertical displacement of first movable partition 28 within first chamber 960 and “resetting” first chamber 960 for any subsequent controlled release of first foamable composition 940.

A bleed hole or a first unidirectional valve 31 is provided for readily facilitating the flow of air back into first upper conduit 980, such that first movable partition 28 can be readily displaced substantially downwards by gravitational forces.

For the purpose of enhancing the downward displacement of first movable partition 28, by way of example occasioning on first container 900 being inverted, at least one first bias 34 is attached to or integrally formed with first movable partition 28 such that first bias 34 applies an increasing downward force on first movable partition 28 as first movable partition 28 is displaced substantially vertically upward in first chamber 960.

Thus, upon release of flow guide 1172, first bias 34 displaces first movable partition 28 substantially vertically downwards within first chamber 960.

Thus, first container 900 of the present invention is clearly advantageous in as much that inversion of first container 900 during application does not impede proper application of first foamable composition 940 due to first chamber 960 being substantially filled with first foamable composition 940 prior to inverted.

First movable partition 28 is constructed of a material selected from the group consisting of: a resilient material, a semi-resilient material, a vulcanized material, a rubber, a silicone, a polymer and a plasticized material.

First movable partition 28 is constructed of a material having a sufficient specific weight to readily facilitate downward vertical displacement of first movable partition 28 within first chamber 960 against the resistance of first foamable composition 940 having varying viscosity.

First sealer 30 is constructed of a material selected from the group consisting of: a resilient material, a semi-resilient material, a vulcanized material, a rubber, a silicone, a polymer and a plasticized material

Kit 1158 also includes a second container 900′. Second container 900′ includes a second pressurized gas 920′ and a second foamable composition 940′ under pressure created by second gas 920′ in second container 900′.

Second foamable composition 940′ has a characteristic selected from the group consisting of: a fluid, a liquid and a semi-liquid.

Second container 900′ preferably further includes a second chamber 94, wherein chamber is attached to, or integrally formed with, a second upper conduit 96 and a second lower conduit 1000′, thereby readily facilitating flow of liquids, fluids and gas from second lower conduit 1000′ through second chamber 960′ and through second upper conduit 96.

Second lower conduit 1000′ is immersed in second foamable composition 940′ such that second gas 920′ readily displaces second foamable composition 940′ through second lower conduit 1000′ into second chamber 960′ and through second upper conduit 96, pursuant to a user downwardly displacing flow guide 1172, attached to or integrally formed with second upper conduit 96.

A user can readily release second foamable composition 940′ from second container 900′ by depressing upper surface 1174 of flow guide 1172 thereby opening a second valve 1176′ attached to, or integrally formed with flow guide 1172, such that flow of second gas 920′ from second container 900′ is readily facilitated, thereby bringing about a complimentary flow of second foamable composition 940′ from second container 900′ out through second valve 1176′.

For the purpose of controlling the release of second foamable composition 940′ from first container second valve 1176′, a second movable partition 28′ is situated in second chamber 960′ such that upon second foamable composition 940′ being displaced by second gas 920′, a complimentary substantially upward vertical displacement of second movable partition 28′ is brought about.

Second movable partition 28′ includes a second sealer 30′ for substantially sealing second upper conduit 96 subsequently to second movable partition 28′ being displaced upwards beyond a predetermined point.

Second movable partition 28′ includes at least one second release valve 32′ formed in second movable partition 28′ for readily facilitating bleeding of second foamable composition 940′ and second gas 920′ through second release valve 32′ formed in second movable partition 28′.

Thus, subsequent to a user depressing upper surface 1174 of flow guide 1172, second movable partition 28′ is displaced substantially vertically upwards, within second chamber 960′, by second gas 920′ and/or second foamable composition 940′ until second sealer 30′ seals second upper conduit 96 or until the user releases flow guide 1172 thereby closing second valve 1176′.

Thereafter, gravity applies a substantially vertical force on second movable partition 28′. As such, second gas 920′ and/or second foamable composition 940′ “bleed” through second valve 32′ formed in second movable partition 28′, thereby readily facilitating substantially downward vertical displacement of second movable partition 28′ within second chamber 960′ and “resetting” second chamber 960′ for any subsequent controlled release of second foamable composition 940′.

A bleed hole or a second unidirectional valve 31′ is provided for readily facilitating the flow of air back into second upper conduit 96, such that second movable partition 28′ can be readily displaced substantially downwards by gravitational forces.

For the purpose of enhancing the downward displacement of second movable partition 28′, by way of example occasioning on second container 900′ being inverted, at least one second bias 110 is attached to or integrally formed with second movable partition 28′ such that second bias 110 applies an increasing downward force on second movable partition 28′ as second movable partition 28′ is displaced substantially vertically upward in second chamber 960′. Thus, upon release of flow guide 1172, second bias 110 displaces second movable partition 28′ substantially vertically downwards within second chamber 960′.

Thus, second container 900′ of the present invention is clearly advantageous in as much that inversion of second container 900′ during application does not impede proper application of second foamable composition 940′ due to second chamber 960′ being substantially filled with second foamable composition 940′ prior to inverted.

Second movable partition 28′ is constructed of a material selected from the group consisting of: a resilient material, a semi-resilient material, a vulcanized material, a rubber, a silicone, a polymer and a plasticized material.

Second movable partition 28′ is constructed of a material having a sufficient specific weight to readily facilitate downward vertical displacement of second movable partition 28′ within second chamber 960′ against the resistance of second foamable composition 940′ having varying viscosity.

Second sealer 30′ is constructed of a material selected from the group consisting of: a resilient material, a semi-resilient material, a vulcanized material, a rubber, a silicone, a polymer and a plasticized.

Flow guide 1172 is attached to or integrally formed with first upper conduit 980 and second upper conduit 96.

Flow guide 1172 includes a first outlet port 1112 for releasing first foamable composition 940 separately.

Flow guide 1172 also includes a second outlet port 1114 formed in Flow guide 1172 for readily releasing second foamable composition 940′ separately from first foamable composition 940, such that first foamable composition 940 and second foamable composition 940′ are substantially contemporaneously mixed and/or combined when first foamable composition 940 and second foamable composition 940′ are released from first container 900 and second container 900′ respectively.

Thus, kit 1158 including first container 900 and second container 900′ as described hereinabove readily facilitate providing a measure or dose of first foamable composition 940 and/or second foamable composition 940′ stored in a first pressurized container 900 and second pressurized container 900′ respectively, and the ability to substantially contemporaneously mix and/or combine first foamable composition 940 and/or second foamable composition 940′ being released from first container 900 and/or second container 900′.

As described briefly, with reference to FIG. 1, the hollow extensions 70 and 1000′ can be adapted for inverse use of the canisters where the hollow extensions are formed to describe a “u” within the canister so that the hollow extension end is submerged when the canister is inverted.

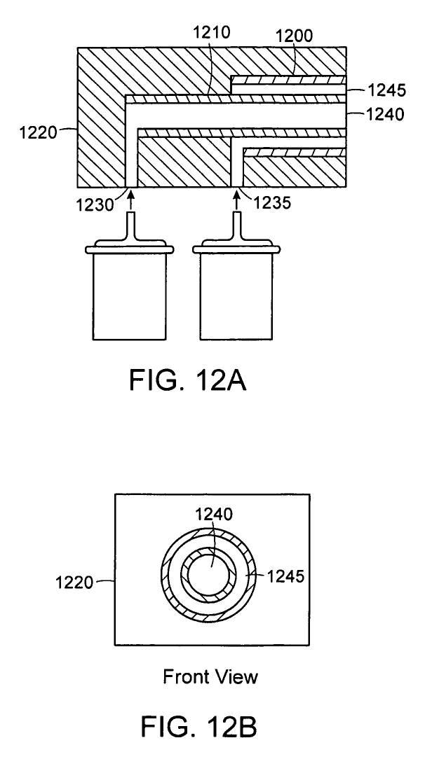

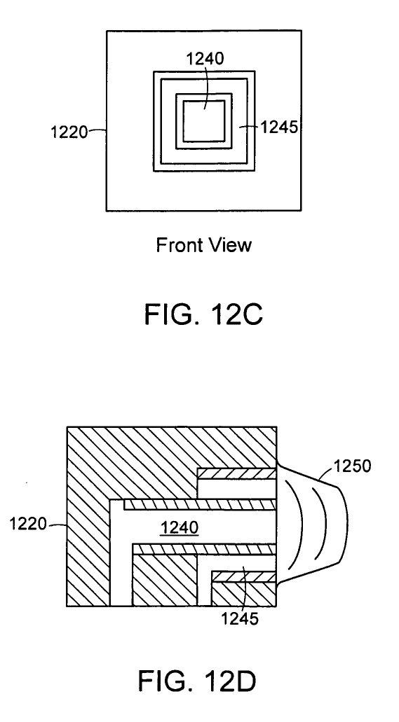

FIGS. 12A, 12B, 12C and 12D illustrate one or more embodiments in which at least two flow conduits are coaxial to one another. In other words, an outer conduit 1200 forms an annular ring or conduit around an inner conduit 1210 in a flow guide 1220 having inlets 1230, 1235 and outlets 1240, 1245, respectively. FIGS. 12A, 12B, 12C and 12D provide various views of a first outer conduit in which a smaller inner conduit is positioned. The outer conduit delivers foamed composition to a location external to the head from a first container, while the inner conduit carries a foamed composition from a second container. The cross-sectional area of each conduit may be the same or different. The outer diameter or width of the outer conduit is bigger than the outer diameter or width of the inner conduit. FIGS. 12B and 12C illustrate a front view of the outlet ports of the outer conduit and the inner conduit having different cross-sectional geometries.

In one or more embodiments of the invention described in FIGS. 12A, 12B, 12C and 12D, the inner foam and the outer foams exit in parallel such that the inner foam is substantially covered and encompassed by the outer foam.

In still further cases, a flow path can describe a funnel with the exit being the widest point or diameter or an inverse funnel where the exit is the narrowest point or diameter. In still further cases, a flow path can describe a corkscrew.

FIG. 12D further illustrates in cross-section exit shield 1250, which surrounds the first and second outlet ports and positioned in a way to allow mixing and/combining of the first and second composition and also to allow spraying of the compositions in a controlled direction. The shield is of sufficient volume that it does not constrain the foam product on exit.

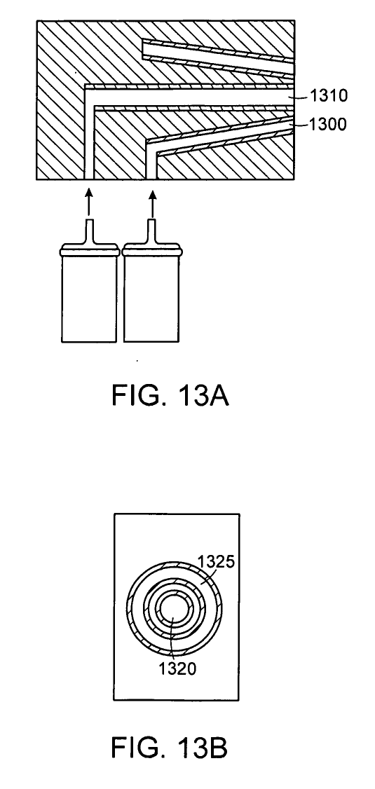

FIG. 13A illustrates a cross sectional view of coaxial conduits according to one or more embodiments. As will be appreciated in this embodiment, the outer foam exits towards the inner exiting foam whilst the expanding inner foam exits straight ahead. In other words, the outer foam exits at an angle from the outer circular outlet directed towards the exiting inner foam. The outer foam exits at an angle towards a point along an axis extending along the center of the inner flow conduit external to the flow guide and will therefore converge with the inner foam exiting along an axis extending along the centre of the inner flow conduit. This arrangement may facilitate the combination, interaction and or mixing of the outer foam with the inner foam.

In a further embodiment of the invention of FIGS. 13A and 13B (not shown), the inner foam outlet is further adapted to direct the inner foam at least partly in an outward direction so as to facilitate convergence with the outer exiting foam.

In this embodiment, an outer conical-shaped conduit 1300 forms an annular ring around an inner conduit 1310. The outer conduit delivers foamed composition to a location external to the head, from a first container, while the inner conduit carries a foamed composition from a second conduit. The conical shape of flow conduit 1310 changes the angle of merger of the trio of foams as it is dispensed. FIG. 13B shows a front view of coaxial conduits according to one or more embodiments.

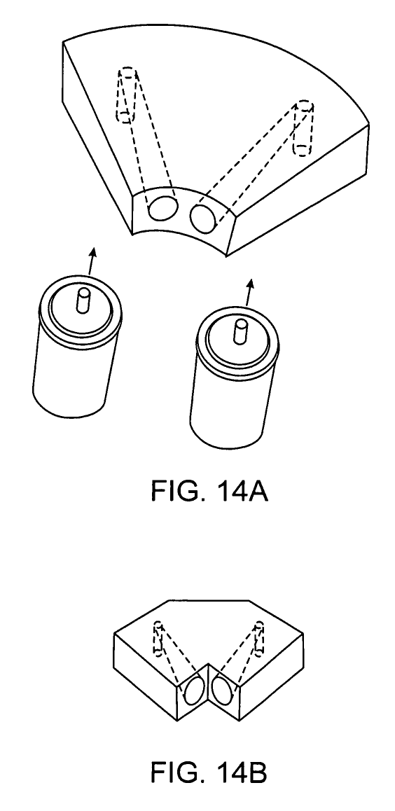

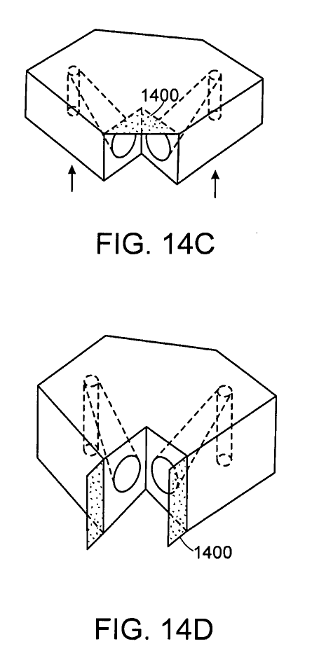

FIG. 14A is schematic perspective view of a dispenser head which contains flow conduits that can vary in its cross-section area so as to allow foam to expand when exiting the outlet ports. Additionally, FIG. 14A illustrates a curved sidewall of the dispenser head where the outlet ports terminate. The enlarging flow conduit helps to accommodate the expanding foamed composition as it is dispensed.

FIG. 14B shows an alternative dispenser head which contains flow conduits that can vary in its cross-section area so as to allow foam to expand when exiting the outlet ports. In addition, FIG. 14B shows an angled sidewall of the dispenser head, and wherein the angle can be adjusted to be, for example, at about 30 degree, about 60 degree, about 90 degree, or about 120 degree to allow optimal mixing or combining of two foams.

FIGS. 14C and 14D show an alternative dispenser head which contains flow conduits that can vary in its cross-section area so as to allow foam to expand when exiting the outlet ports. In addition, FIGS. 14C and 14D show an angled sidewall of the dispenser head, and wherein the angle can be adjusted to be, for example, at about 30 degree, about 60 degree, about 90 degree, or about 120 degree to allow a desired level of combining or mixing of two foams. Furthermore, FIGS. 14C and 14D illustrate an exit shield 1400 that can surround the first and second outlet ports and positioned in a way to allow mixing and/combining of the first and second composition and also to allow spraying of the compositions in a controlled direction. The exit shield is adapted so that the outlet area can be cleaned after use.

It is envisaged that the container can be a non aerosol mechanical foamer. By way of example only, such a non aerosol mechanical container can be selected from the group consisting of non aerosol mechanical foamers as disclosed in U.S. Pat. Nos. 4,018,396; 4,440,320; 4,603,812 and 4,738,396 all of which are hereby incorporated in their entirety by reference.

In other embodiments, the plurality of containers may include a trap attached to or integrally formed with the second container. The term “trap” can include but is not be limited to an arrangement in a pipe, as a double curve or a U-shaped section, in which liquid remains and forms a seal for preventing the passage or escape of air or gases through the pipe, to secure a quantity of emulsion, liquid or semi liquid and to store a quantity of liquid, emulsion or semi liquid. The trap is geared towards nullifying any adverse effects from gravity and creates a reservoir within the trap. Thus, agitation or shaking of the container traps a quantity of foamable composition within trap, thereby creating a reservoir of foamable composition.

As used herein, the term “agitation” shall include but will not be limited to: the state of being displaced or the amount or degree to which something is displaced, the linear or angular distance in a given direction between a body or point and a reference position, the distance of an oscillating body from its equilibrium position, shaking, to move or force into violent, or irregular action, to shake or move briskly, to move with short, quick, vibratory movements and to move something, esp. in a bottle or container, briskly to and fro or up and down, as in mixing.

FIGS. 12A, 12B, 12C and 12D illustrate one or more embodiments in which at least two flow conduits are coaxial to one another. In other words, an outer conduit 1200 forms an annular ring or conduit around an inner conduit 1210 in a flow guide 1220 having inlets 1230, 1235 and outlets 1240, 1245, respectively. FIGS. 12A, 12B, 12C and 12D provide various views of a first outer conduit in which a smaller inner conduit is positioned. The outer conduit delivers foamed composition to a location external to the head from a first container, while the inner conduit carries a foamed composition from a second container. The cross-sectional area of each conduit may be the same or different. The diameter or width of the outer conduit is bigger than that of the inner conduit. FIGS. 12B and 12C illustrate a front view of the outlet ports of the outer conduit and the inner conduit having different cross-sectional geometries.

FIG. 12D further illustrates in cross-section exit shield 1250, which surrounds the first and second outlet ports and positioned in a way to allow mixing and/combining of the first and second composition and also to allow spraying of the compositions in a controlled direction. The shield is of sufficient volume that it does not constrain the foam product on exit.

FIG. 13A illustrates a cross sectional view of coaxial conduits according to one or more embodiments. In this embodiment, an outer conical-shaped conduit 1300 forms an annular ring around an inner conduit 1310. The outer conduit delivers foamed composition to a location external to the head, from a first container, while the inner conduit carries a foamed composition from a second conduit. The conical shape of flow conduit 1310 changes the angle of merger of the trio of foams as it is dispensed. FIG. 13B shows a front view of coaxial conduits according to one or more embodiments.

FIGS. 14A is schematic perspective view of a dispenser head which contains flow conduits that can vary in its cross-section area so as to allow foam to expand when exiting the outlet ports. Additionally, FIG. 14A illustrates a curved sidewall of the dispenser head where the outlet ports terminate. The enlarging flow conduit helps to accommodate the expanding foamed composition as it is dispensed.

FIG. 14B shows an alternative dispenser head which contains flow conduits that can vary in its cross-section area so as to allow foam to expand when exiting the outlet ports. In addition, FIG. 14B shows an angled sidewall of the dispenser head, and wherein the angle can be adjusted to be, for example, at about 30 degree, about 60 degree, about 90 degree, or about 120 degree to allow optimal mixing or combining of two foams.

FIGS. 14C and 14D show an alternative dispenser head which contains flow conduits that can vary in its cross-section area so as to allow foam to expand when exiting the outlet ports. In addition, FIGS. 14C and 14D show an angled sidewall of the dispenser head, and wherein the angle can be adjusted to be, for example, at about 30 degree, about 60 degree, about 90 degree, or about 120 degree to allow optimal mixing or combining of two foams. Furthermore, FIGS. 14C and 14D illustrate an exit shield 1400 that can surround the first and second outlet ports and positioned in a way to allow mixing and/combining of the first and second composition and also to allow spraying of the compositions in a controlled direction.

According to one or more embodiments, the “content” or “foamable composition” may include an active agent directed to the treatment of a medical disorder or a cosmetic disorder. The cosmetic foam compositions of the present invention are suitable for the further application as “cosmeceutical” preparation (cosmetic products with therapeutic benefit), to treat “cosmetic” skin disorders, such as aging skin, wrinkles, hyperpigmentation (melasma, chloasma, freckles, etc.), scaly skin and other bioabnormalities. In one or more embodiments, the active agent is unstable or reactive in the presence of one or more components of the foam composition and the active agent is contained in a container separate from those components. The active agent can be categorized by the benefit it provides or by its postulated mode of action. The active agents can in some instances provide more than one benefit or operate via more than one mode of action. Therefore, classifications are made for the sake of convenience and are not intended to limit the active to that particular application or applications listed. Furthermore, foam compositions, with or without further active ingredients, are suitable for the application as “cosmeceutical” preparations.

In one or more embodiments, the active agent is selected from the group consisting of an anti-infective, an antibiotic, an antibacterial agent, an antifungal agent, an antiviral agent, an antiparasitic agent, an steroidal antiinflammatory agent, an immunosuppressive agent, an immunomodulator, an immunoregulating agent, a hormonal agent, vitamin A, a vitamin A derivative, vitamin B, a vitamin B derivative, vitamin C, a vitamin C derivative, vitamin D, a vitamin D derivative, vitamin E, a vitamin E derivative, vitamin F, a vitamin F derivative, vitamin K, a vitamin K derivative, a wound healing agent, a disinfectant, an anesthetic, an antiallergic agent, an alpha hydroxyl acid, lactic acid, glycolic acid, a beta-hydroxy acid, a protein, a peptide, a neuropeptide, a allergen, an immunogenic substance, a haptene, an oxidizing agent, an antioxidant, a dicarboxylic acid, azelaic acid, sebacic acid, adipic acid, fumaric acid, a retinoid, an antiproliferative agent, an anticancer agent, a photodynamic therapy agent, an anti-wrinkle agent, a radical scavenger, a metal oxide (e.g., titanium dioxide, zinc oxide, zirconium oxide, iron oxide), silicone oxide, an anti wrinkle agent, a skin whitening agent, a skin protective agent, a masking agent, an anti-wart agent and a refatting agent.

In one or more embodiments, a first active agent is contained in one container and a second active agent is contained in a second container. Locating the two active agents in two separate chambers is important in many cases, including, but not limited to the following examples:

1. The two active agents are incompatible with each other. For example, if one active agent is a base and the other is an acid, they will undergo an acid-base reaction. Likewise, if one active agent is an oxidizer and the other is a reducing agent of a freed radical scavenger, they will undergo a redox reaction.

2. Each active agent is incompatible with different formulation excipients. For example, if one active agent is stable at a given pH range and the other active agent is unstable at the same pH range, including them in the same chamber will result in an unstable drug system.

3. Each active agent is soluble in a different solvent system.

Hence, locating two active agents is two separate chambers is important to produce drugs that will retain high stability for long storage periods.

In addition to an active agent, the foamable composition may include a wide variety of nonlimiting cosmetic and pharmaceutical ingredients commonly used in the skin care industry, which are suitable for use in the compositions of the present invention. Examples of these ingredient classes include: abrasives, absorbents, aesthetic components such as fragrances, pigments, colorings/colorants, essential oils, astringents, etc. (e.g., clove oil, menthol, camphor, eucalyptus oil, eugenol, menthyl lactate, witch hazel distillate), anti-acne agents, anti-caking agents, antifoaming agents, antimicrobial agents (e.g., iodopropyl butylcarbamate), antioxidants, binders, biological additives, buffering agents, bulking agents, chelating agents, chemical additives, colorants, cosmetic astringents, cosmetic biocides, denaturants, drug astringents, external analgesics, film formers or materials, e.g., polymers, for aiding the film-forming properties and substantivity of the composition (e.g., copolymer of eicosene and vinyl pyrrolidone), opacifying agents, pH adjusters, propellants, reducing agents, sequestrants, skin bleaching and lightening agents (e.g., hydroquinone, kojic acid, ascorbic acid, magnesium ascorbyl phosphate, ascorbyl glucosamine), skin-conditioning agents (e.g., humectants, including miscellaneous and regulating residence of an active ingredient in the skin), skin soothing and/or healing agents (e.g., panthenol and derivatives (e.g., ethyl panthenol), aloe vera, pantothenic acid and pantothenic acid derivatives, allantoin, bisabolol, and dipotassium glycyrrhizinate), skin treating agents, thickeners, and vitamins and derivatives thereof.

In any embodiment of the present invention, however, the active agents useful herein can be categorized by the benefit they provide or by their postulated mode of action. It is to be understood that the active agents useful herein can in some instances provide more than one benefit or operate via more than one mode of action. Therefore, classifications herein are made for the sake of convenience and are not intended to limit the active to that particular application or applications listed.

By including an appropriate active agents in the compositions of the present invention, the composition are useful in treating a patient having any one of a variety of dermatological disorders, which include inflammation as one or their etiological factors (also termed “dermatoses”), such as classified in a non-limiting exemplary manner according to the following groups:

Dermatitis including contact dermatitis, atopic dermatitis, seborrheic dermatitis, nummular dermatitis, chronic dermatitis of the hands and feet, generalized exfoliative dermatitis, stasis dermatitis; lichen simplex chronicus; diaper rash;

Bacterial infections including cellulitis, acute lymphangitis, lymphadenitis, erysipelas, cutaneous abscesses, necrotizing subcutaneous infections, staphylococcal scalded skin syndrome, folliculitis, furuncles, hidradenitis suppurativa, carbuncles, paronychial infections, erythrasma;

Fungal Infections including dermatophyte infections, yeast Infections; parasitic Infections including scabies, pediculosis, creeping eruption;

Viral Infections;

Disorders of hair follicles and sebaceous glands including acne, rosacea, perioral dermatitis, hypertrichosis (hirsutism), alopecia, including male pattern baldness, alopecia areata, alopecia universalis and alopecia totalis; pseudofolliculitis barbae, keratinous cyst;

Scaling papular diseases including psoriasis, pityriasis rosea, lichen planus, pityriasis rubra pilaris;

Benign tumors including moles, dysplastic nevi, skin tags, lipomas, angiomas, pyogenic granuloma, seborrheic keratoses, dermatofibroma, keratoacanthoma, keloid;

Malignant tumors including basal cell carcinoma, squamous cell carcinoma, malignant melanoma, paget's disease of the nipples, kaposi's sarcoma;

Reactions to sunlight, including sunburn, chronic effects of sunlight, photosensitivity;

Bullous diseases including pemphigus, bullous pemphigoid, dermatitis herpetiformis, linear immunoglobulin A disease;

Pigmentation disorders including hypopigmentation such as vitiligo, albinism and postinflammatory hypopigmentation and hyperpigmentation such as melasma (chloasma), drug-induced hyperpigmentation, postinflammatory hyperpigmentation;

Disorders of cornification including ichthyosis, keratosis pilaris, calluses and corns, actinic keratosis;

Pressure sores

Disorders of sweating; and

Inflammatory reactions including drug eruptions, toxic epidermal necrolysis; erythema multiforme, erythema nodosum, granuloma annulare.

Likewise, the composition, can be topically applied to a body cavity or mucosal surfaces, including, but not limited to the cranial cavity, the thoratic cavity, the abdominal cavity, the venteral cavity, the vagina, the rectum and penile cavities, the urinary tract, the nasal cavity, the mouth, the eye, the ear the peritoneum, the large and small bowel, the caecum, bladder, and stomach, the cavity between the uterus and the fallopian tubes, the ovaries and other body areas, which may accept topically-applied products. The composition of the present invention is suitable to treat conditions of a body cavity and a mucosal membrane, such as post-surgical adhesions, chlamydia infection, gonorrhea infection, hepatitis B, herpes, HIV/AIDS, human papillomavirus (HPV), genital warts, bacterial vaginosis, candidiasis, chancroid, granuloma Inguinale, lymphogranloma venereum, mucopurulent cervicitis (MPC), molluscum contagiosum, nongonococcal urethritis (NGU), trichomoniasis, vulvar disorders, vulvodynia, vulvar pain, yeast infection, vulvar dystrophy, vulvar intraepithelial neoplasia (VIN), contact dermatitis, pelvic inflammation, endometritis, salpingitis, oophoritis, genital cancer, cancer of the cervix, cancer of the vulva, cancer of the vagina, vaginal dryness, dyspareunia, anal and rectal disease, anal abscess/fistula, anal cancer, anal fissure, anal warts, Crohn's disease, hemorrhoids, anal itch, pruritus ani, fecal incontinence, constipation, polyps of the colon and rectum.

According to one or more embodiments of the present invention, the compositions are also useful in the therapy of non-dermatological disorders by providing transdermal delivery of a steroid that is effective against non-dermatological disorders.

All references cited herein are incorporated herein by reference in their entirety and for all purposes to the same extent as if each individual publication or patent or patent application was specifically and individually indicated to be incorporated by reference in its entirety for all purposes. To the extent publications and patents or patent applications incorporated by reference contradict the disclosure contained in the specification, the specification is intended to supercede and/or take precedence over any such contradictory material.

It will be appreciated that the above descriptions are intended to only serve as examples, and that many other embodiments are possible within the spirit and scope of the present invention.

From the foregoing, it will be recognized that the present invention provides a unique dispenser unit that can improve the reliability of simultaneous dispensing of the contents of two containers, and in particular can ensure proper mixing even though the components of the foam are separated stored and combined just before use. The invention also enables the dispenser unit to be used with containers having different types of contents without having to modify a large part of the structure of the unit.

Many modifications and other embodiments of the invention will come to mind to one skilled in the art to which this invention pertains having the benefit of the teachings presented in the foregoing descriptions and the associated drawings. For instance, the kit may be equipped with a meter for recording the dosing or the actuation of the kit may be run by a computer program. The dispenser head may also include a pressure equalizer.

It is also possible to use the dispenser unit with unpressurized containers having pumps for dispensing the contents. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A dispenser head for use with a plurality of containers, comprising:
(a) an actuator, wherein the dispensing head is structured and positioned to be an actuator or comprises an actuator button disposed within the dispensing head to simultaneously actuate the plurality of containers
(b) a flow guide comprising
(A) a plurality of flow conduits disposed within the flow guide; and
(B) for each of the plurality of flow conduits,
(ii) an inlet through a wall of the flow guide connecting with a flow conduit; and
(iii) an outlet from a flow conduit through a wall of the flow guide;
(C) and for each of the plurality of inlets and containers, a linker, each to link an inlet and a container to allow the contents of the container upon actuation to pass through the inlet and through the flow conduit to reach and pass through the outlet;
(D) and wherein the flow guide is structured and positioned to allow simultaneous flow communication between each of the plurality of flow conduits and wherein the plurality of outlets are structured and positioned to allow substantially contemporaneously dispensing and/or combining of the content from a plurality of containers external to the dispensing head.

2. The head of claim 1 wherein the linker is a hollow stem projecting out of a container and adapted to fit within the inlet through which the contents of the container are dispensed when the stem is activated,

3. The head of claim 1 wherein each foamable composition/foam remains segregated from the other foamable compositions/foams until they commence exiting through the outlets substantially simultaneously.

4. The head of claim 1 wherein any combining, interaction and or mixing substantially contemporaneously of the content from the plurality of outlet ports occurs substantially at a location external to the dispensing head.

5. A dispenser head for use with a plurality of containers, each of the containers having a hollow stem through which contents are dispensed when the stem is activated, comprising:
(a) a member structured and positioned to engage a hollow stem from each of a plurality of containers;
(b) a plurality of flow conduits, each of the plurality of flow conduits comprising an inlet port and an outlet port and a connecting conduit between them defining a flow path and each said inlet port capable of flow communication with a stem of a container;
(c) a flow guide accommodating at least a portion of each of said plurality of flow conduits, wherein said flow guide defines a flow direction at the outlet port for each said flow guide,
wherein each said flow conduit defines a segregated flow path such that mixing between different container contents is prevented prior to a substantially contemporaneously dispensing of the contents from the plurality of outlet ports to a location external to the dispensing head.

6. The dispenser head of claim 5, wherein the flow direction at the outlet ports facilitates combining, interaction or mixing substantially contemporaneously of the content from the plurality of outlet ports at a location external to the dispensing head.

7. The dispenser head of claim 5, wherein the cross-sectional areas of each of the plurality of flow conduits is substantially the same.

8. The dispenser head of claim 5, wherein the cross-sectional area of at least one flow conduit is greater than those of the other plurality of flow conduits.

9. The dispenser head of claim 5, wherein the cross-sectional area of one flow conduit varies along its length.

10. The dispenser head of claim 9, wherein the cross-sectional area of the flow conduit increases along its length.

11. The dispenser head of claim 5, wherein the flow guide is rigid and is structured and positioned to engage a hollow stem from each of a plurality of pressurized containers.

12. The dispenser head of claim 5, wherein the flow guide defines a flow path between an inlet port on a first sidewall of the flow guide and an outlet port on a second sidewall of the flow guide.

13. The dispenser head of claim 5, wherein the flow guide defines a flow path between an inlet port on a face of the flow guide and an outlet port on a sidewall of the flow guide.

14. The dispenser head of claim 5, further comprising at least two flow conduits in flow communication with at least two pressurized containers

15. The dispenser head of claim 5, further comprising three or more flow conduits in flow communication with three or more pressurized containers.

16. The dispenser head of claim 5, wherein a first flow conduit comprises a first outlet port and a first flow conduit comprises a first outlet port and said flow guide defines a flow path such that said first and second outlet ports are adjacent to one another.

17. The dispenser head of claim 5, wherein said flow guide defines a direction such that first outlet and said second outlet are positioned to direct container content towards one another so as to allow mixing at a location external to the dispenser head.

18. The dispenser head of claim 5, wherein said flow guide defines a flow direction such that outlets are positioned to direct container contents adjacent to one another at a location external to the dispenser head.

19. The dispenser head of claim 5, wherein the flow guide defines an angle of convergence the plurality of flow conduits.

20. The dispenser head of claim 19, wherein the angle is in the range of 30° to 120°.

21. The dispenser head of claim 19, wherein the flow conduits converge in a ‘v’ shape.

22. The dispenser head of claim 5, wherein the flow path of the flow conduit through the flow guide is curvilinear.

23. The dispenser head of claim 5, wherein the flow path of the flow conduit through the flow guide is linear.

24. The dispenser head of claim 5, further comprising an applicator, wherein the applicator or spreader is connected to the flow guide at said plurality of outlet ports.

25. The dispenser head of claim 5, wherein the diameter of a first flow conduit is smaller than that of a second flow conduit and the first and second flow conduits are co-axial.

26. The dispenser head of claim 25 wherein each of the conduits describes a passageway of substantially the same cross sectional area

27. The dispenser head of claim 25, wherein the foam exiting the first flow conduit outlet is surrounded by a second foam exiting from a the second flow conduit outlet wherein the first and second flow conduits are co-axial.

28. The dispenser head of claim 5 wherein the second outlet is adapted so that second foam is substantially directed at an angle into the first foam

29. The dispenser head of claim 5 wherein the outlets are adapted so that the second foam is substantially directed to the first foam and the second foam is in part substantially directed to the first foam

30. The dispenser head of claim 5, further comprising a flow-controlling device mounted between the flow guide and the actuator.

31. The dispenser head of claim 5, further comprising an exit shield substantially surrounding said plurality of outlet ports.

32. The dispenser head of claim 5, wherein a member structured and positioned to engage a hollow stem is positioned substantially perpendicular to the container.

33. The dispenser head of claim 5, wherein a member structured and positioned to engage a hollow stem is substantially in plane with the container.

34. The dispenser head of claim 5, wherein the flow guide further comprises a rotatable disk housed within the flow guide, wherein the outlet ports are located in the rotatable disk.

35. The dispenser head of claim 5, wherein a portion of each flow conduits comprises an elongated conduit spanning said member and said flow guide.

36. The dispenser head of claim 35, wherein the elongated conduit comprises a flexible tube

37. The dispenser head of claim 37, wherein the flow guide accommodates a portion of the elongated conduit at a location distal from the inlet port.

38. A kit for contemporaneously mixing and/or combining a plurality of foamable compositions, comprising a plurality of pressurized containers, each said pressurized containing comprising a foamable composition;
(A) a member structured and positioned to engage a hollow stem from each of a plurality of containers;
(B) a plurality of flow conduits, each of the plurality of flow conduits comprising an inlet port and an outlet port and each said inlet port capable of flow communication with a stem of a container;
(C) a flow guide accommodating at least a portion of each of said plurality of flow conduits, wherein said flow guide defines a flow direction at the outlet port for each said flow guide,
(D) wherein each said flow conduit defines a substantially segregated flow path such that substantially no mixing of container contents occurs prior to a substantially contemporaneously dispensing of the content from the plurality of outlet ports to a location external to the dispensing head.

39. The kit of claim 30, wherein the cross-sectional areas of each of the plurality of flow conduits is substantially the same.

40. The kit of claim 30, wherein the cross-sectional area of at least one flow conduit is greater than those of the other plurality of flow conduits.

41. The kit of claim 30, wherein the cross-sectional area of one flow conduit varies along its length.

42. The kit of claim 33, wherein the cross-sectional area of the flow conduit increases along its length.

43. The kit of claim 30, wherein the flow guide is rigid and is structured and positioned to engage a hollow stem from each of a plurality of pressurized containers.

44. The kit of claim 30, wherein the flow guide defines a flow path between an inlet port on a first sidewall of the flow guide and an outlet port on a second sidewall of the flow guide.

45. The kit of claim 30, wherein the flow guide defines a flow path between an inlet port on a face of the flow guide and an outlet port on a sidewall of the flow guide.

46. The kit of claim 30, further comprising at least two flow conduits in flow communication with at least two pressurized containers

47. The kit of claim 30, further comprising three or more flow conduits in flow communication with three or more pressurized containers.

48. The kit of claim 30, wherein a first flow conduit comprises a first outlet port and a first flow conduit comprises a first outlet port and said flow guide defines a flow path such that said first and second outlet ports are adjacent to one another.

49. The kit of claim 38, wherein said flow guide defines a direction such that first outlet and said second outlet are positioned to direct container content towards one another so as to allow mixing at a location external to the dispenser head.

50. The kit of claim 30, wherein said flow guide defines a flow direction such that outlet are positioned to direct container contents adjacent to one another at a location external to the dispenser head.

51. The kit of claim 30, wherein the flow guide defines an angle of convergence the plurality of flow conduits.

52. The kit of claim 43, wherein the angle is in the range of 30° to 120°.

53. The kit of claim 43, wherein the flow conduits converge in a ‘v’ shape.

54. The kit of claim 30, wherein the flow path of the flow conduit through the flow guide is curvilinear.

55. The kit of claim 30, wherein the flow path of the flow conduit through the flow guide is linear.

56. The kit of claim 30, further comprising an applicator, wherein the applicator is connected to the flow guide at said plurality of outlet ports.

57. The kit of claim 38, wherein the diameter of a first flow conduit is smaller than that of a second flow conduit and the first and second flow conduits are co-axial.

58. The kit of claim 49, wherein the cross-sectional areas of flow for the first and second flow paths are substantially the same.

59. The kit of claim 30, further comprising a flow-controlling device mounted between the flow guide and the actuator.

60. The kit of claim 30, further comprising an exit shield substantially surrounding said plurality of outlet ports.

61. The kit of claim 30, wherein a member structured and positioned to engage a hollow stem is positioned perpendicular to the container.

62. The kit of claim 30, wherein a member structured and positioned to engage a hollow stem is in plane with the container.

63. The kit of claim 30, wherein the flow guide further comprises a rotatable disk housed within the flow guide, wherein the outlet ports are located in the rotatable disk.

64. The kit of claim 30, wherein a portion of each flow conduits comprises an elongated conduit spanning said member and said flow guide.

65. The kit of claim 30, wherein the elongated conduit consists of a flexible tube.

66. The kit of claim 30, wherein at least one of the plurality of foam compositions comprises a therapeutically effective agent.

67. The kit of claim 30, wherein at last one container comprises:
(A) a first foamable composition;
(B) a first pressurized gas;
(C) a first valve for releasing said first foamable composition from said first container;
(D) a first metering chamber in fluid communication with said first container and said first valve, said first metering chamber having a first upper wall and a first lower wall and defining a volume proportionate to a predetermined quantity of said first foamable composition to be delivered; and
(E) a first movable partition comprising a first seal located in said first metering chamber, said first movable partition capable of moving from a first resting position spaced apart from said first valve to a second sealing position in sealing arrangement with said first valve.

68. The kit of claim 59, wherein a plurality of containers comprise:
(A) a second foamable composition;
(B) a second pressurized gas;
(C) a second valve for releasing said first foamable composition from said second container;
(D) a second metering chamber in fluid communication with said second container and said second valve, said second metering chamber having a second upper wall and a second lower wall and defining a volume proportionate to a predetermined quantity of said second foamable composition to be delivered; and
(E) a second movable partition comprising a second seal located in said second metering chamber, said second movable partition capable of moving from a first resting position spaced apart from said second valve to a second sealing position in sealing arrangement with said second valve.

69. A kit for contemporaneously mixing and/or combining a plurality of foamable compositions, comprising a plurality of pressurized containers, each said pressurized containing comprising a foamable composition;
(a) an actuator, wherein the dispensing head is structured and positioned to be an actuator or comprises an actuator button disposed within the dispensing head to simultaneously actuate the plurality of containers
(b) a flow guide comprising
(A) a plurality of flow conduits disposed within the flow guide; and
(B) for each of the plurality of flow conduits,
(ii) an inlet through a wall of the flow guide connecting with a flow conduit; and
(iii) an outlet from a flow conduit through a wall of the flow guide;
(C) and for each of the plurality of inlets and containers, a linker, each to link an inlet and a container to allow the contents of the container upon actuation to pass through the inlet and through the flow conduit to reach and pass through the outlet;
and wherein the flow guide is structured and positioned to allow simultaneous flow communication between each of the plurality of flow conduits and wherein the plurality of outlets are structured and positioned to allow substantially contemporaneously dispensing and/or combining of the content from a plurality of containers external to the dispensing head.

70. A therapeutic kit comprising:
(a) a dual aerosol dispenser including:
(i) a first container including:
(A) a first foamable composition comprising a therapeutically active agent;
(B) a first pressurized gas;
(C) a first valve for releasing said first foamable composition from said first container;
(D) a first metering chamber in fluid communication with said first container and said first valve, said first metering chamber having a first upper wall and a first lower wall and defining a volume proportionate to a predetermined quantity of said first foamable composition to be delivered; and
(E) a first movable partition comprising a first seal located in said first metering chamber, said first movable partition capable of moving from a first resting position spaced apart from said first valve to a second sealing position in sealing arrangement with said first valve; and
(ii) a second container including:
(A) a second foamable composition;
(B) a second pressurized gas;
(C) a second valve for releasing said first foamable composition from said second container;
(D) a second metering chamber in fluid communication with said second container and said second valve, said second metering chamber having a second upper wall and a second lower wall and defining a volume proportionate to a predetermined quantity of said second foamable composition to be delivered; and
(E) a second movable partition comprising a second seal located in said second metering chamber, said second movable partition capable of moving from a first resting position spaced apart from said second valve to a second sealing position in sealing arrangement with said second valve.
(iii) an actuator attached to the stems of the first container and the second container for substantially contemporaneously mixing and/or combining the first foamable composition and the second foamable composition.

71. A method for substantially contemporaneously mixing and/or combining two compositions being released comprising:
(a) providing a therapeutic kit according to claim 1;
(b) actuating said third valve for releasing the first foamable composition and the second foamable composition from the first and the second container.

72. A method of dispensing a foam, comprising:
(A) providing a kit according to claim 30; and
(B) displacing the member to actuate said plurality of stem valves, so as to dispense a plurality of foamed compositions along a plurality of substantially segregated flow paths such that substantially no mixing of container contents occurs prior to a substantially contemporaneously dispensing of the content from the plurality of outlet ports to a location external to the dispensing head.

73. The method of claim 73, wherein at least one of the plurality of foam compositions comprises a therapeutically effective agent.

74. Use of the kit of claim 71 in the treatment of a disorder.
